(19) United States
(12) Patent Application Publication
(10) Pub. No.: US 2026/0286772 A1
(43) Pub. Date: Sep. 24, 2026

(54) WINDOW SHADE HAVING BALANCING DRIVE SYSTEM

(71) Applicant: Nien Made Enterprise Co., Ltd., Taichung City (TW)

(72) Inventors: Lin Chen, Taichung City (TW); Cheng-Chi Liang, Taichung City (TW)

(73) Assignee: Nien Made Enterprise Co., Ltd., Taichung City (TW)

(21) Appl. No.: 19/553,474

(22) Filed: Mar. 2, 2026

(30) Foreign Application Priority Data
Mar. 18, 2025 (CN) 202520473147.6
Nov. 18, 2025 (CN) 202522447412.6

(51) Int. Cl. E06B 9/60

(52) U.S. Cl. CPC E06B 9/60

(57) ABSTRACT

Disclosed is a window shade with a balancing drive system including a base, a power assembly, an adjusting assembly, and a friction member. The poser assembly includes a coil spring. The adjusting assembly includes two reels and a transmission cord connected therebetween. One of the base and a first reel of the reels is fixedly connected to the bracket, and the other can be driven by the roller to rotate. When an extendable component connected to the roller is operated to be wound or unwound, a relative rotation between the base and the receiving reel occurs, causing the transmission cord to be released from one reel and wound onto the other by turn, during which the loops of at least one of the reels gradually varying in radius, thereby adjusting an elastic force provided by the power assembly to the roller. Thus, the user can effortlessly operate the window shade.

### BACKGROUND OF THE DISCLOSURE

### 1. Field of the Disclosure

The present disclosure generally relates to a window shade, and more particularly relates to a window shade having a balancing drive system, in which the balancing drive system provides a variable elastic force to the roller of the window shade, and such an elastic force varies with a load of the roller as the cover material of the window shade is retracted or extended.

### 2. Description of the Prior Art

For enhancing safety in the use of curtains, cordless window coverings have been introduced to improve a conventional curtain arrangement in which a continuous cord loop is used to control retraction and extension of a curtain, thereby eliminating exposed pull cords that may otherwise cause entanglement hazard to children or pets. A cordless window covering in the form of a roller blind is exemplified below. To operate such a cordless roller blind, a user directly pulls down the cover material to extend it, or directly pushing up a distal end of the cover material, causing the cover material to be retracted onto the roller tube. Once the user stops downward pulling or upward pushing, the distal end of the cover material stops moving immediately and stays still at the current position. Therefore, the user can extend the cover material to a desired length, and keep the cover material staying in place. The acting principle of the cordless roller blind is to utilizing a helical spring engaged with the roller tube, which is twisted to accumulate energy while the cover material is pulled downward, and releases the energy while the distal end of the cover material is pushed upward for retracting the cover material back onto the roller tube, so that the user can operate the roller blind with reduced effort. Regarding a window covering in the form of a roller blind, as the extended length of its cover material increases, the load tension exerted on the roller tube by the weight of the cover material also increases. Once the user stops downward pulling or upward pushing, an elastic force provided by the helical spring functions as a balancing torque, counteracting most of the load tension exerted on the roller tube by the weight of the cover material. With the friction generated among components of the roller blind, the roller blind remains in position after the halt of downward pulling or upward pushing. However, the helical springs are high-costing in material and manufacture, and their length is too long for the window coverings with narrow cover materials.

For substituting the helical springs, a current design utilizes a coil spring, which is easier to manufacture and lower in cost, to be bent in a S shape and connected between two rotary wheels to function as a power outputting module. However, each time a user operates the cordless roller blind, the user may stop the distal end of the cover material at any position, resulting in different extended lengths of the cover material that require different magnitude of the balancing torque. However, the above- mentioned power outputting module made of the coil spring can only provide an elastic force in generally constant value, which could not vary with different extended lengths of the cover material. Necessarily, the elastic force is set to be applicable to a situation that the roller tube bears the maximum load tension, causing the user to operate the cordless roller blind with increased effort.

Likewise, the cordless window coverings in the other form have the similar problem when using low-cost coil springs to function as the power outputting module. A cordless window covering in the form of a roman blind is exemplified below, which includes a shading body downward extending from an upper crossbeam and a driving roller shade arranged behind the shading body. The driving roller shade includes a cover body connected with the shading body, so that the shading body is driven to be folded or unfolded while retraction or extension of the driving roller shade. Moreover, the cover body partially supports the weight of a folded portion of the shading body that has been already folded. The cover body of the driving roller shade is so light in weigh that can be neglect with respect to the weight of the shading body. Therefore, during extension of the driving roller shade, an unfolded portion of the shading body is elongated as a released length of the cover body increases, and the weight of the unfolded portion of the shading body is changed to be borne by the upper crossbeam, thereby reducing the load tension acting on the roller tube. However, since the elastic force outputted by the coil spring would not vary, the power outputting module should provide the roller tube with an elastic force that is great enough for ensuring the roller tube can fully retract the cover body to fully fold the shading body. As a result, while the user pulls the driving roller shade for unfolding the shading body, the longer a released length of the cover body of the driving roller shade, the lesser the load tension acting on the roller tube and the greater an additional force required to be applied by the user, resulting in the user operating with gradually increased effort as the released length of the cover body increases.

### SUMMARY OF THE DISCLOSURE

Regarding a cordless window covering with a roller tube, it is known that as the cover body is extended, the load on the roller tube varies with the released length of the cover body. When using a coil spring to provide a driving force to the roller tube of the cordless window covering on the purpose of lowering cost, the driving force provided by the coil spring is necessarily set to correspond to a situation that the roller tube bears the maximum load, because it could not vary with extension of the cover body. As a result, the user is required to exert increased effort to extend the cordless window covering.

In order to solve the problem of laborious operation when the user pulling down the window blind and concurrently keep lower manufacture cost, one aspect of the present disclosure is to provide a window shade, including a roller, a first and second bracket, an extendable component, and a balancing drive system. The first and second brackets are disposed immovable relative to an architecture and spaced apart from each other. The roller is disposed between the first and second brackets, and is operably rotatable around a first axis. The extendable component has one end edge connected to the roller, so that the extendable component can be wound onto or unwound from the roller. The balancing drive system is operatively connected to the roller, and includes a base, a power assembly, an adjusting assembly, and a friction member. The base is disposed to correspond to one end of the roller and disposed within a chamber of the roller. The power assembly is disposed on the base, and includes a rotary-drive member and a coil spring. The rotary-drive member is rotatably connected to the base. The coil spring has one end connected to the rotary-drive member, so that the coil spring can be wound onto or unwound from the rotary-drive member according to a rotation direction of the rotary-drive member.

The adjusting assembly includes an output reel, a receiving reel, and a transmission cord. The output reel is connected to the base and is rotatable around an output-center axis relative to the base. Moreover, the output reel is drivingly connected to the rotary-drive member, so that the output reel is subjected to an elastic torque substantially continuously provided by the coil spring. The receiving reel is connected to the base and having a receiving-center axis parallel to the first axis. The base and the receiving reel are configured to allow for a relative rotation occurring therebetween. The transmission cord has a first and second end fixed on the output reel and the receiving reel, respectively. The transmission cord is wound on at least one of the output reel and the receiving reel, and remains in a taut state. The friction member is directly or indirectly connected with the power assembly and provides a frictional resistance to the roller.

When the extendable component is operated by an external force to move, the extendable component is wound onto the roller, or unwound from the roller. When the extendable component is unwound from the roller, the transmission cord is wound successively on the receiving reel to form plural receiving loops. When the extendable component is wound onto the roller, the transmission cord is wound successively on the output reel to form plural output loops. The plural receiving loops and/or the plural output loops are wound with radii thereof gradually varying correspondingly with a released length of the extendable component that has been unwound from the roller.

In one embodiment of the present disclosure, the friction member is disposed between the output reel and the receiving reel, and the transmission cord contacts and goes around the friction member. Preferably, the friction member includes at least one shaft pin disposed on the base and extending in a direction parallel to the output-center axis. The transmission cord has a part located between the output reel and the receiving reel and interfered by the at least one shaft pin to be bent. When the transmission cord moves or tends to move relative to the at least one shaft pin, the frictional resistance is generated between the transmission cord and the at least one shaft pin.

In one embodiment of the present disclosure, the friction member is located between the power assembly and the adjusting assembly, and is drivingly connected to the output reel. Preferably, the friction member includes a pair of bevel gears engaged with each other, in which one of the bevel gears is drivingly connected to the output reel, and the other is drivingly connected to the rotary-drive member. When the output reel and the rotary-drive member rotate, the pair of bevel gears are driven to rotate, thereby generating the frictional resistance.

In one embodiment of the present disclosure, the balancing drive system further includes a rotary-transmission member, which is connected with the roller and is rotatable together with the roller. The base is connected with the first bracket and is immovable relative to the first bracket. The rotary-transmission member is drivingly connected to the receiving reel for driving the receiving reel to rotate around the receiving-center axis. The elastic torque is transmitted via the output reel, the friction member, the transmission cord, the receiving reel, and the rotary-transmission member to provide an elastic force to the roller. When the external force is removed, a greater released length of the extendable component corresponds to a greater load borne by the roller. The plural receiving loops and/or the plural output loops are wound with radii thereof gradually increasing as the released length of the extendable component increases, thereby increasing the elastic force acting on the roller as the load borne by the roller increases.

Preferably, the rotary-transmission member is fixedly connected with the receiving reel, and the receiving reel includes a receiving slot, which has an annular shape and is centered on the receiving-center axis. The receiving slot restricts the transmission cord such that after winding X turns around the receiving reel, the transmission cord is stacked onto a subsequent layer, resulting in the receiving loops stacked on one another to form plural stacking layers when the extendable component is fully unwound form the roller, in which X is one of 1, 2, and 3. While the extendable component is unwound from the roller and the transmission cord is wound onto the receiving reel, the stacking layers increase in number correspondingly with an increase of the receiving loops in number, so that radii of the receiving loops gradually increase. Additionally or alternatively, the rotary-transmission member is fixedly connected to the output reel. The output reel has an output slot, which has an annular shape and is centered on the output-center axis. The output slot restricts the transmission cord such that after winding Y turns around the output reel, the transmission cord is stacked onto a succeeding layer, resulting in the output loops stacked on one another to form plural coiling layers when the extendable component is fully wound on the roller, in which Y is one of 1, 2, and 3. While the extendable component is wound onto the roller and the transmission cord is wound onto the output reel, the coiling layers increase in number correspondingly with an increase of the output loops in number, so that radii of the output loops gradually increase.

Preferably, the rotary-transmission member has one end extending into the base and having a transmission-splined shaft portion. The receiving reel includes a conical cylinder, a receiving slot, and a gear portion. The conical cylinder is centered on the receiving-center axis. The receiving slot extends helically along and on the conical cylinder. The gear portion is connected to the conical portion and engaged with the transmission-splined shaft portion of the transmission-splined shaft portion. The second end of the transmission cord fixed on the receiving reel is close to a small-radius end of the conical cylinder. Therefore, while the extendable component is unwound from the roller, the transmission cord is wound on the conical cylinder along the receiving slot, causing radii of the receiving loops to gradually increase during winding. Additionally or alternatively, the rotary-transmission member has one end extending into the base and having a transmission-splined shaft portion. The receiving reel includes a gear portion engaged with the transmission-splined shaft portion. The output reel includes a tapered cylinder and an output slot, in which the tapered cylinder is centered on the output-center axis, and the output slot extends helically along and on the tapered cylinder. The first end of the transmission cord fixed on the output reel is close to a narrow end of the tapered cylinder. Therefore, when the extendable component is wound on the roller, the transmission cord is wound on the tapered cylinder along the output slot, causing radii of the output loops to gradually increase during winding.

In one embodiment of the present disclosure, the balancing drive system further includes a rotary-transmission member, which is connected with the roller and is rotatable together with the roller. The base is connected with the first bracket and is immovable relative to the first bracket. The rotary-transmission member is drivingly connected to the receiving reel for driving the receiving reel to rotate around the receiving-center axis. Meanwhile, the window shade is a roman shade, further including an upper rail and a shading structure. The upper rail is fixedly disposed on the architecture. The first and second brackets are fixedly disposed on the upper rail and spaced apart from each other, and the roller is rotatable around the first axis relative to the upper rail. The shading structure has a top end edge connected to the upper rail. Moreover, the extendable component is connected with the shading structure, such that the extendable component drives the shading structure to be folded successively from bottom to top while being operated by the external force to be wound on the roller, and drives the shading structure to be unfolded successively from top to bottom while being operated by the external force to be unwound from the roller. Wherein, the elastic torque is transmitted via the output reel, the transmission cord, the receiving reel, the friction member, and the rotary-transmission member to provide an elastic force to the roller. When the external force is removed, a greater released length of the extendable component corresponds to a lesser load borne by the roller. The plural receiving loops and/or the plural output loops are wound with radii thereof gradually decreasing as the released length of the extendable component increases, thereby reducing the elastic force acting on the roller as the load borne by the roller decreases.

Preferably, the rotary-transmission member has one end extending into the base and having a transmission-splined shaft portion, and the receiving reel includes a conical cylinder, a receiving slot and a gear portion. The conical cylinder is centered on the receiving-center axis. The receiving slot extends helically along and on the conical cylinder. The gear portion is connected to the conical portion and engaged with the transmission-splined shaft portion. The second end of the transmission cord fixed on the receiving reel is close to a large-radius end of the conical cylinder. Therefore, while the extendable component is unwound from the roller, the transmission cord is wound on the conical cylinder along the receiving slot, causing radii of the receiving loops to gradually decrease during winding. Additionally or alternatively, the rotary-transmission member has one end extending into the base and having a transmission-splined shaft portion. The receiving reel includes a gear portion engaged with the transmission-splined shaft portion. The output reel includes a tapered cylinder and an output slot. The tapered cylinder is centered on the output-center axis. The output slot extends helically along and on the tapered cylinder. The first end of the transmission cord fixed on the output reel is close to a wide end of the tapered cylinder. Therefore, while the extendable component is wound onto the roller, the transmission cord is wound on the tapered cylinder along the output slot, causing radii of the output loops to gradually decrease during winding.

In one embodiment of the present disclosure, the balancing drive system further includes a fixed axle disposed to correspond to the one end of the roller. The fixed axle is connected with the first bracket and is immovable relative to the first bracket. The receiving reel is mechanically coupled with the fixed axle. The base is engaged with the roller to be rotatable around the first axis with the roller, and the base is rotatably connected with the receiving reel. The elastic torque is transmitted via the output reel, the transmission cord, the friction member, and the receiving reel to provide an elastic force to the roller. When the external force is removed, a greater released length of the extendable component corresponds to a greater load borne by the roller. The plural receiving loops and/or the plural output loops are wound with radii thereof gradually increasing as the released length of the extendable component increases, thereby increasing the elastic force acting on the roller as the load borne by the roller increases.

Preferably, the receiving reel is fixedly connected to the fixed axle and includes a receiving slot having an annular shape and is centered on the receiving-center axis. The receiving slot restricts the transmission cord such that after winding X turns around the receiving reel, the transmission cord is stacked onto a subsequent layer, resulting in the receiving loops stacked on one another to form plural stacking layers when the extendable component is fully unwound form the roller, in which X is one of 1, 2, and 3. While the extendable component is unwound from the roller and the transmission cord is wound onto the receiving reel, the stacking layers increase in number correspondingly with an increase of the receiving loops in number, so that radii of the receiving loops gradually increase. Additionally or alternatively, the receiving reel is fixedly connected to the fixed axle, and the output reel includes an output slot, which has an annular shape and is centered on the output-center axis. The output slot restricts the transmission cord such that after winding Y turns around the output reel, the transmission cord is stacked onto a succeeding layer, resulting in the output loops stacked on one another to form plural coiling layers when the extendable component is fully wound on the roller, in which Y is one of 1, 2, and 3. While the extendable component is wound onto the roller and the transmission cord is wound onto the output reel, the coiling layers increase in number correspondingly with an increase of the output loops in number, so that radii of the output loops gradually increase.

Preferably, the fixed axle has one end extending into the chamber of the roller and having a fixed-splined shaft portion. The receiving reel includes a conical cylinder, a receiving slot, and a gear portion. The conical cylinder is centered on the receiving-center axis. The receiving slot extends helically along and on the conical cylinder. The gear portion is connected to the conical portion and engaged with the fixed-splined shaft portion, so that the receiving reel is configured to rotate around the receiving-center axis relative to the base while the base rotates. The second end of the transmission cord fixed on the receiving reel is close to a small-radius end of the conical cylinder. Therefore, while the extendable component is unwound from the roller, the transmission cord is wound on the conical cylinder along the receiving slot, causing radii of the receiving loops to gradually increase during winding. Additionally or alternatively, the fixed axle has one end extending into the chamber of the roller and having a fixed-splined shaft portion. The receiving reel includes a gear portion engaged with the fixed-splined shaft portion, so that the receiving reel is configured to rotate around the receiving-center axis relative to the base while the base rotates. The output reel includes a tapered cylinder and an output slot, in which the tapered cylinder is centered on the output-center axis, and the output slot extends helically along and on the tapered cylinder. The first end of the transmission cord fixed on the output reel is close to a narrow end of the tapered cylinder. Therefore, while the extendable component is wound onto the roller, the transmission cord is wound on the tapered cylinder along the output slot, causing radii of the output loops to gradually increase during winding.

In one embodiment of the present disclosure, the balancing drive system further includes a fixed axle disposed to correspond to the one end of the roller. The fixed axle is connected with the first bracket and is immovable relative to the first bracket. The receiving reel is mechanically coupled with the fixed axle. The base is engaged with the roller to be rotatable around the first axis with the roller, and the base is rotatably connected with the receiving reel. Meanwhile, the window shade is a roman shade, further including an upper rail and a shading structure. The upper rail is fixedly disposed on the architecture. The first and second brackets are fixedly disposed on the upper rail and spaced apart from each other, and the roller is rotatable around the first axis relative to the upper rail. The shading structure has a top end edge connected to the upper rail. Moreover, the extendable component is connected with the shading structure, such that the extendable component drives the shading structure to be folded successively from bottom to top while being operated by the external force to be wound on the roller, and drives the shading structure to be unfolded successively from top to bottom while being operated by the external force to be unwound from the roller. The elastic torque is transmitted via the friction member, the output reel, the transmission cord, and the receiving reel to provide an elastic force to the roller. When the external force is removed, a greater released length of the extendable component corresponds to a lesser load borne by the roller. The plural receiving loops and/or the plural output loops are wound with radii thereof gradually decreasing as the released length of the extendable component increases, thereby reducing the elastic force acting on the roller as the load borne by the roller decreases.

Preferably, the fixed axle has one end extending into the chamber of the roller and having a fixed-splined shaft portion. Moreover, the receiving reel includes a conical cylinder, a receiving slot, and a gear portion. The conical cylinder is centered on the receiving-center axis. The receiving slot extends helically along and on the conical cylinder. The gear portion is connected to the conical portion and engaged with the fixed-splined shaft portion so that the receiving reel is configured to rotate around the receiving-center axis relative to the base while the base rotates. The second end of the transmission cord fixed on the receiving reel is close to a large-radius end of the conical cylinder. Therefore, while the extendable component is unwound from the roller, the transmission cord is wound on the conical cylinder along the receiving slot, causing radii of the receiving loops to gradually decrease during winding. Additionally or alternatively, the fixed axle has one end extending into the chamber of the roller and having a fixed-splined shaft portion. The receiving reel includes a gear portion engaged with the fixed-splined shaft portion, so that the receiving reel is configured to rotate around the receiving-center axis relative to the base while the base rotates. The output reel includes a tapered cylinder and an output slot, in which the tapered cylinder is centered on the output-center axis, and the output slot extends helically along and on the tapered cylinder. The first end of the transmission cord fixed on the output reel is close to a wide end of the tapered cylinder. Therefore, while the extendable component is wound onto the roller, the transmission cord is wound on the tapered cylinder along the output slot, causing radii of the output loops to gradually decrease during winding.

The window shade having the balancing drive system of the present disclosure uses the coil spring as a power source, and adjusts the magnitude of the power and the frictional resistance through the winding manner of the transmission cord during power transmission, so as to provide a variable elastic force to the roller. Therefore, the window shade of the present disclosure at least has the following advantages:
(1) Compared to the conventional cordless roller blinds, the window shade of the present disclosure uses the coil spring to replace the helical spring for lowering cost in material and manufacture, but still maintains the function of providing a variable elastic force to the roller as that of the helical spring. Thus, after being moved by an external force, the extendable component stops immediately and stays still as the external force is removed, resulting in well operating experience of the user.
(2) Compared to the conventional roman blinds in which a driving force exerted on the roller tube could not vary with the load borne by the roller tube, the window shade of the present disclosure provides an elastic force that is variable to the roller through the balancing drive system, thereby addressing the issue in the conventional roman blinds where excessive elastic force results in increased operating effort for the user.
(3) Regarding the window shade of the present disclosure, the balancing drive system thereof includes a friction member, which further provides a frictional resistance that is variable additionally to provision of the elastic force that is variable. Such a variable frictional resistance can offset insufficiency of a system’s maximum static friction, so that the coil springs of limited specifications can fit various window shades more precisely and flexibly.
(4) Regarding the window shade of the present disclosure, the balancing drive system thereof has a structure beneficial to being compact in total length as well as occupying less space within the roller of the window shade, thereby being applicable to the size-customized window shades with narrow width.

These and other objectives of the present disclosure will no doubt become obvious to those of ordinary skill in the art after reading the following detailed description of the preferred embodiment that is illustrated in the various figures and drawings.

### BRIEF DESCRIPTION OF THE DRAWINGS

The present disclosure will be understood by referring to the following detailed description of some illustrative embodiments in conjunction with the accompanying drawings, in which:

FIG. 1 is a perspective view of the window shade, according to a first embodiment of the present disclosure;

FIG. 2 is a partial see-through and partial exploded view of the window shade in FIG. 1;

FIG. 3 is a partial perspective cross-section view of the balancing drive system, the sleeve member, and the connecting member in FIG. 2, in which the side surface S1 of the base faces upward in the figure;

FIG. 4 is a perspective view of the balancing drive system in FIG. 2 from another view angle, omitting the fixed axle, in which the side surface S1 of the base faces downward in the figure;

FIG. 5 is an exploded view of the balancing drive system in FIG. 4;

FIG. 6 is a cross-sectional view of the balancing drive system in FIG. 4 taken along the line A-A, showing the state of the transmission cord when the extendable component is fully wound on the roller;

FIG. 6A is a view similar to FIG. 6, showing the state of the transmission cord when the extendable component is fully unwound from the roller;

FIG. 7 is a view similar to FIG. 6A, showing another exemplified friction member and one of the interfering and winding manner of the transmission cord on the friction member;

FIG. 7A is another view similar to FIG. 6A, showing the exemplified friction member as shown in FIG. 7, and showing another interfering and winding manner of the transmission cord on the friction member;

FIG. 8 is a perspective view of another variant of the balancing drive system of the window shade in FIG. 1;

FIG. 9 is a perspective view of the fixed axle of the balancing drive system in FIG. 8;

FIG. 10 is a cross-sectional view of the balancing drive system in FIG. 8 taken along the line B-B;

FIG. 11 is a perspective view of the window shade, according to a second embodiment of the present disclosure;

FIG. 12 is a partial see-through view of the window shade in FIG. 11, omitting the extendable component;

FIG. 13 is a cross-sectional view of the balancing drive system in FIG. 12 taken along the line C-C;

FIG. 14 is a perspective view of the balancing drive system in FIG. 12 from another view angle, omitting the rotary-transmission member, the protecting sleeve, and part of the base;

FIG. 15 is a partial see-through, exploded, and enlarged view of the window shade in FIG. 12, omitting the extendable component;

FIG. 16 is a perspective view of the window shade, according to a third embodiment of the present disclosure, in which the window shade is in the fully-extended state;

FIG. 17 is a perspective view of the window shade in FIG. 16 from another view angle;

FIG. 18 is a partial see-through view of the window shade in FIG. 17, omitting the fixed axle and the extendable component;

FIG. 19 is a lateral view of the window shade in FIG. 16, in which the window shade is fully-unfolded;

FIG. 20 is a view similar to FIG. 19, in which the window shade is fully-folded;

FIG. 21 is a cross-sectional view of the balancing drive system and the first end plug in FIG. 18 taken along the line D-D, in which the side surface S2 of the base faces downward in the figure;

FIG. 22 is a perspective view of the balancing drive system and the first end plug in FIG. 18 from another view angle, in which the side surface S2 of the base faces upward in the figure;

FIG. 23 shows the balancing drive system and the first end plug in FIG. 22, omitting part of the base;

FIG. 24 is a lateral view of the window shade, according to the first embodiment of the present disclosure, omitting the first bracket;

FIG. 25 shows a relationship between an upward force provided by the balance driving system and a downward force acting on the roller versus a released length of the extendable component, according to the first embodiment of the present disclosure;

FIG. 26 shows a relationship between an upward force provided by the balance driving system, a downward force acting on the roller, and an operating force exerted by the user versus a released length of the extendable component, according to the fourth embodiment of the present disclosure.

### DETAILED DESCRIPTION

In the following paragraphs and the accompanying drawings, the features and the implementations of several embodiments of the present disclosure are described in more detail along with the accompanying drawings. The features and the implementations described in the following paragraphs can be adopted solely or in combination with each other. In addition, the embodiments can be modified in various forms, as disclosed in the following paragraphs, and should not be limited to the embodiments described in the following paragraphs. Unless specified otherwise, the same reference characters refer to the same components.

The technical features provided in the present disclosure are not limited to the specific structures, uses, and applications described in the embodiments. The language used in the descriptions is illustrative and descriptive language which can be understood by the person of ordinary skill in the art. The terms regarding directions mentioned in the specification, including “front”, “rear”, “up”, “down”, “left”, “right”, “top”, “bottom”, “inside”, and “outside”, are illustrative and descriptive terms based on common usage scenarios, and manifests no intent to limit the scope of claims.

Furthermore, the definite and indefinite articles “a” and “the” and the numerical term “one” used in the specification referring to components of singular form do not exclude the concept of plural form. Equivalences known by one having ordinary skill in the art should be also included. All conjunctions used in similar situations should be interpreted in the broadest ways. The specific shapes, structural features, and technical terms described in the descriptions should also be interpreted to include equivalent structures and techniques which could achieve the same functionality.

The window shade of the present disclosure includes a roller, two brackets, an extendable component, and a balancing drive system. The extendable component is connected to the roller such that, as the roller rotates, the extendable component is wound on or unwound from the roller, and the load of the roller varies correspondingly with the released length of the extendable component. The balancing drive system provides an elastic force to the roller which also varies correspondingly with the released length of the extendable component, and the variation trend of the elastic force basically fits with that of the load of the roller. Therefore, the user can operate the window shade with reduced effort. The form of the window shade of the present disclosure may be a roller shade or a roman shade, but is not limited thereto. The window shade may be any cordless-type window shade with a roller. Plural embodiments in conjunction with the accompanying drawings will be exemplified below for further illustrating the features of the present disclosure.

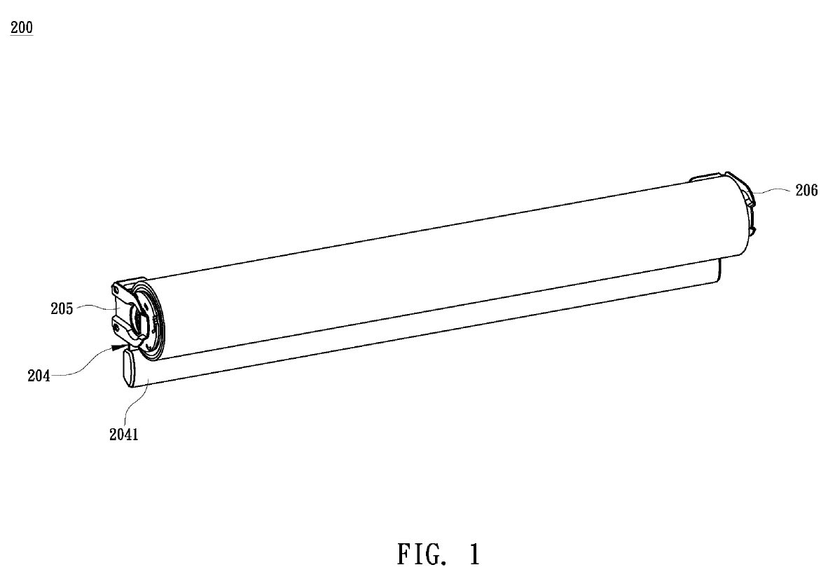

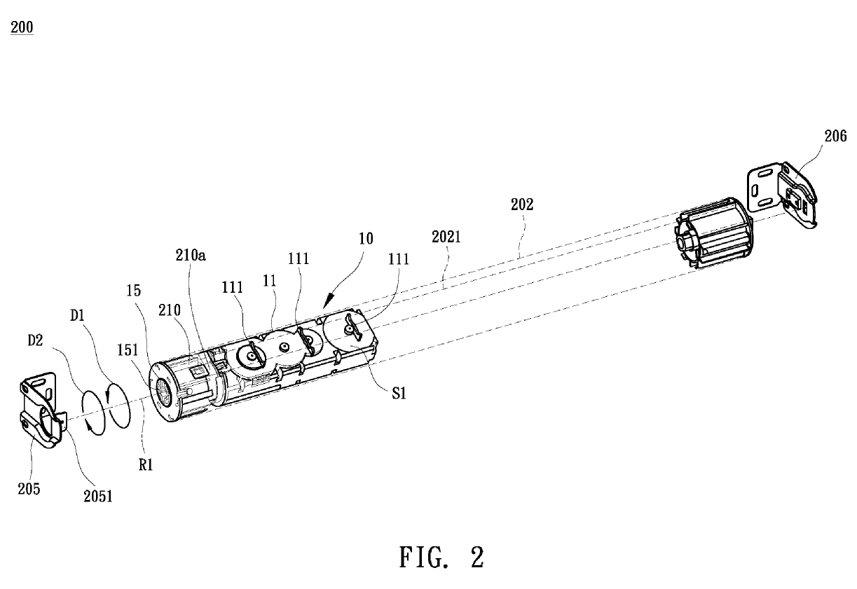

Please refer to FIGS. 1 and 2. According to the first embodiment of the present disclosure, the window shade 200 is a roller shade, including a roller 202, an extendable component 204, a first bracket 205, a second bracket 206, a sleeve member 210, and a balancing drive system 10. The first bracket 205 and the second bracket 206 are secured on the architecture and spaced apart from each other. The roller 202 is disposed between the first bracket 205 and the second bracket 206 and is rotatable around a first axis R1. A hollow rib 2021 protrudes out from the inner circumferential surface of the roller 202, and extends in the longitudinal direction, forming a non-circular inner circumferential edge of the roller 202. Preferably, one end edge of the extendable component 204 is provided with a lower rail 2041, which can be operated by a user to move the extendable component 204. More specifically, the user moves the lower rail 2041 upward or downward by hand to operate the window shade 200, whereby the extendable component 204 is correspondingly wound onto or unwound from the roller 202 for adjusting a shading area of the window shade 200.

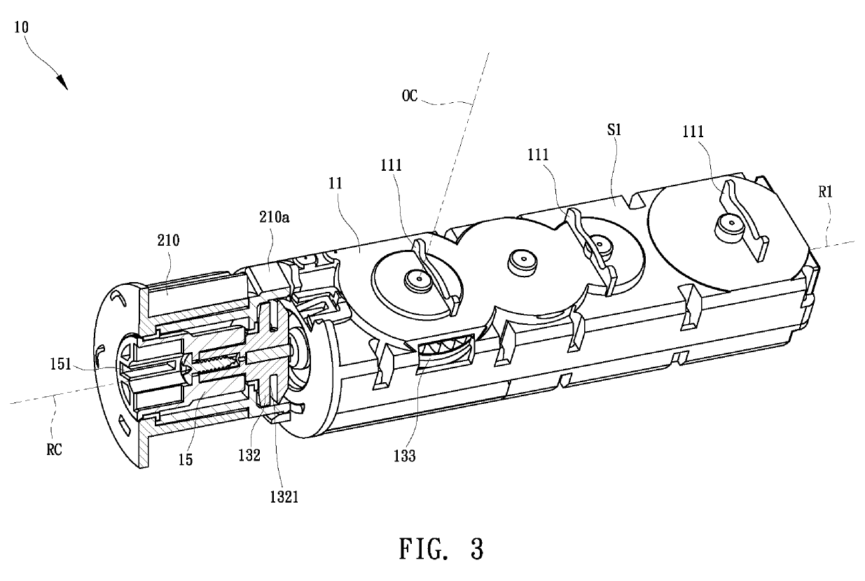

Please refer to FIGS. 2-5. In the present embodiment, the balancing drive system 10 includes a base 11, a power assembly 12, an adjusting assembly 13, a friction member 14, and a fixed axle 15. As shown in FIGS. 2 and 3, the fixed axle 15 has a fixing groove 151 engaged with a tongue 2051 of the first bracket 205, so that the fixed axle 15 is connected with the first bracket 205 in a manner that the fixed axle 15 is non-rotatable relative to the first bracket 205. The sleeve member 210 is rotatably sleeved on the fixed axle 15, and plugged into one end of the roller 202. There are two axial ribs formed on the outside circumferential surface of the sleeve member 210 engaged with outer sides of the hollow rib 2021 protruding from the inner circumferential surface of the roller 202 for rotatably coupling the sleeve member 210 and the roller 202. The base 11 is generally a cuboid and is disposed within the chamber of the roller 202. One side surface S1 of the base 11 is provided with plural engaging ribs 111 protruding outwardly. The shapes of the engaging ribs 111 match with that of the hollow rib 2021 protruding from the inner circumferential surface of the roller 202, and the engaging ribs 111 are engaged with outer sides of the hollow rib 2021. Moreover, the opposite side of the side surface S1 of the base 11 is provided with plural projections 112 protruding outwardly and extending to press against the inner circumferential edge of the roller 202. Therefore, the engaging ribs 111 remain closely-fitted to and engaged with the hollow rib 2021. With this configuration, as the roller 202 rotates around the first axis R1, the base 11 rotates together with the roller 202.

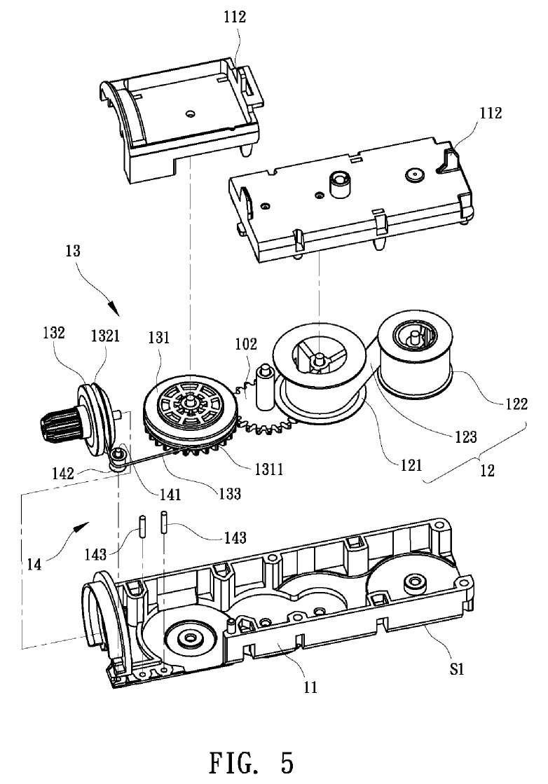

Referring to FIG. 5, the power assembly 12 includes a rotary-drive member 121, a spring-storage wheel 122, and a coil spring 123. The rotary-drive member 121 is rotatably disposed on the base 11. The spring-storage wheel 12 is an idler wheel and is also rotatably disposed on the base 11. As the rotary-drive member 121 rotates in different directions, the coil spring 123 is unwound from the spring-storage wheel 122 and wound onto the rotary-drive member 121, or oppositely unwound from the rotary-drive member 121 and wound onto the spring-storage wheel 122.

Please refer to FIGS. 3 and 5. The adjusting assembly 13 includes an output reel 131, a receiving reel 132, and a transmission cord 133. The output reel 131 is disposed on the base 11 and rotatable around an output-center axis OC relative to the base 11, in which the output-center axis OC is perpendicular to the first axis R1. Moreover, the output reel 131 is drivingly connected to the rotary-drive member 121 of the power assembly 12 through a speed-changing gear 102, such that the output wheel 131 is subjected to an elastic torque substantially continuously provided by the coil spring 123. In addition, the output reel 131 has an output slot 1311 that has an annular shape and is centered on the output-center axis OC. The receiving reel 132 has a receiving-center axis RC parallel to the first axis R1, where the term “parallel” encompasses totally coincident configuration and non-coincident configuration, and the present embodiment illustrates the totally coincident configuration. One end of the receiving reel 132 is secured to the fixed axle 15, and the other end is connected with the base 11 through a pin. Thus, the base 11 is rotatable relative to the receiving reel 132. Moreover, the receiving reel 132 has a receiving slot 1321 that has an annular shape and is centered on the receiving-center axis RC. The transmission cord 133 has a first end fixed on the output slot 1311 of the output reel 131 and a second end fixed on the receiving slot 1321 of the receiving reel 132. The transmission cord 133 is wound on the output slot 1311 of the output reel 131 and/or the receiving slot 1321 of the receiving reel 132, and remains in a taut state constantly.

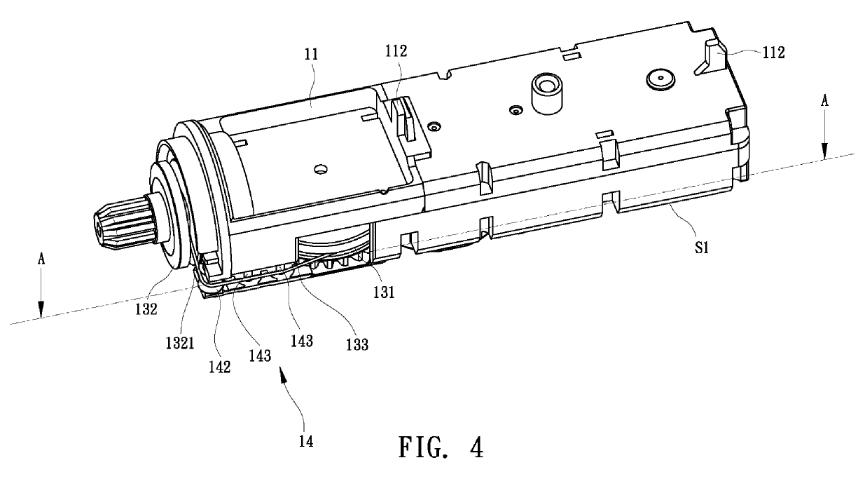

Please refer to FIGS. 4-6. The friction member 14 of the balancing drive system 10 includes a metal shaft pin 141 and a roller 142 sleeved thereon. After extending out from the output slot 1311, the transmission cord 133 goes around and contacts the roller 142. Then, the transmission cord 133 turns its extension direction, and is wound onto the receiving reel 132. Since the transmission cord 133 remains in the taut state and it goes around the roller 142, the roller 142 bias the metal shaft pin 141, thereby generating a frictional resistance. The elastic torque outputted by the power assembly 12 to the output reel 131, is further transmitted, via the output reel 131, the transmission cord 133, the friction member 14, and the receiving reel 132 sequentially, to the roller 202. Therefore, the roller 202 is provided with an elastic force, so that the roller 202 can apply an upward force in the vertical direction to the extendable component 204. The upward force is used to roughly balance a downward force acting upon the roller 202 and produced by the weight of the extendable component 204 (especially the part of the extendable component 204 that is already released from the roller 202, and including the weight of the lower rail 2041).

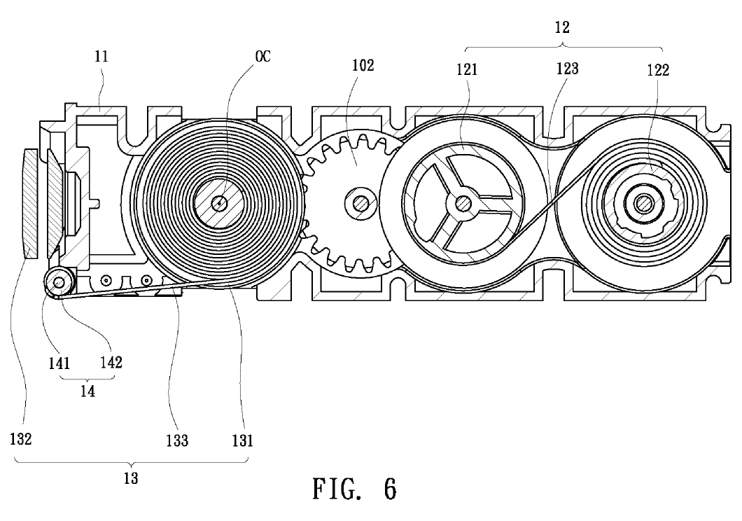

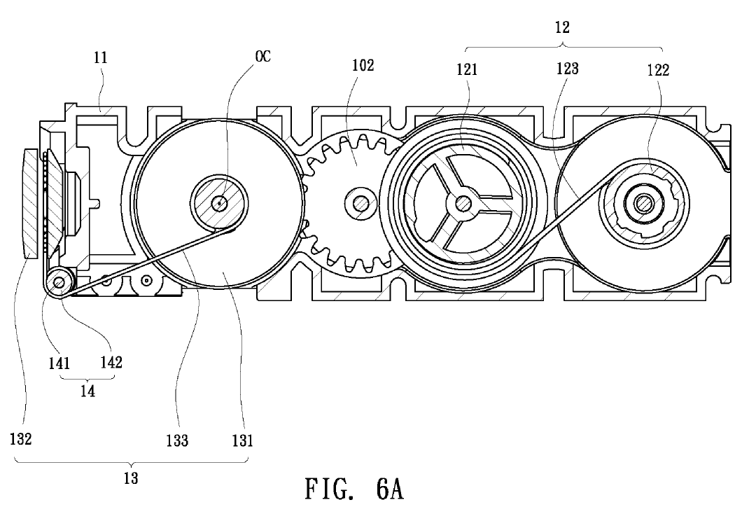

Please refer to FIGS. 1-5, and referring together with FIGS. 6 and 6A. In the present embodiment, to operate the window shade 200, the user moves the lower rail 2041 by hand to exert an external force on the extendable component 204. By doing so, a movement of the extendable component 204 is triggered, thereby adjusting the shading area of the window shade 200. If the user moves down the lower rail 2041, the external force causes the extendable component 204 to extend downward and be released from the roller 202, which drives the roller 202 to rotate in a first direction D1 and further drives the base 11 to rotate relative to the receiving reel 132. Thus, the transmission cord 133 is pulled out of the output slot 1311 of the output reel 131, and wound onto the receiving slot 1321 of the receiving reel 132 successively, thereby forming multiple receiving loops. Meanwhile, a cord tension torque, which is applied by the transmission cord 133 to the output reel 131, is greater than the elastic torque that is applied by the power assembly 12 to the output reel 131, so the output reel 131 rotates around the output-center axis OC in a direction following the pulling direction of the transmission cord 133. The rotation of the output reel 131 drives the rotary-drive member 121 of the power assembly 12 to rotate, causing the coil spring 123 to wind and accumulate energy. Moreover, during winding of the transmission cord 133, a size of the width of the receiving slot 1321 restricts the transmission cord 133 such that after winding one turn on the receiving slot 1321, the transmission cord 133 is stacked onto a subsequent layer. After the extendable component 204 is fully unwound from the roller 202, the transmission cord 133 is wound on the receiving reel 132 and forms multiple receiving loops stacked on one another and centered on the slot bottom of the receiving slot 1321 to form multiple stacking layers. The number of the stacking layers equals the number of the receiving loops. Among the receiving loops stacked in the stacking layers, those positioned in the outer layers have larger radii. In other words, during winding of the transmission cord 133, the stacking layers increases in number correspondingly with an increase of the receiving loops in number, so that the radii of the receiving loops increase with each turn.

In contrast, if the user moves up the lower rail 2041, the external force counteracts the load of the roller 202, causing the cord tension torque, which is applied by the transmission cord 133 to the output reel 131, to be lesser than the elastic torque that is applied by the power assembly 12 to the output reel 131. As a result, the coil spring 123 of the power assembly 12 is unwound from the rotary-drive member 121 of the power assembly 12 and releases the energy, by which the rotary-drive member 121 is driven to rotate, and further drives the output reel 131 of the adjusting assembly 13 to rotate reversely, such that the transmission cord 133 is pulled out of the output slot 1321 of the output reel 132, and wound on the output slot 1311 of the output reel 131 successively, thereby forming multiple output loops. The action of the transmission cord 133 drives the base 11 to actuate the roller 202, so that the roller 202 rotates in a second direction D2 opposite to the first direction D1 to wind up the extendable component 204. Moreover, during winding of the transmission cord 133, a size of the width of the output slot 1311 restricts the transmission cord 133 such that after winding one turn on the output slot 1311, the transmission cord 133 is stacked onto a successive layer. When the extendable component 204 is fully wound on the roller 202 as shown in FIG. 6, the transmission cord 133 is wound on the output reel 132 and forms multiple output loops stacked on one another and centered on the slot bottom of the output slot 1311 to form multiple coiling layers. The number of the coiling layers equals the number of the output loops. Among the output loops stacked in the coiling layers, those positioned in the outer layers have larger radii. In other words, during winding of the transmission cord 133, the coiling layers increases in number correspondingly with an increase of the output loops in number, so that the radii of the output loops gradually increase with each turn.

Regarding the balancing drive system of the window shade in every embodiment of the present disclosure, a perpendicular distance from the position where the transmission cord leaves the receiving reel to the receiving-center axis, is defined as a receiving level arm. Meanwhile, a perpendicular distance from the position where the transmission cord leaves the output reel to the output-center axis, is defined as an output level arm. Such a definition applies throughout the following description and is not repeated hereinafter.

The first embodiment is taken as an example herein for illustrating the acting principle of the balancing drive system of the window shade of the present disclosure. As mentioned above, the receiving slot 1321 of the receiving reel 132, and the output slot 1311 of the output reel 131, both restrict the transmission cord 133 such that after winding one turn thereon, the transmission cord 133 would be stacked to the next layer. Therefore, while the extendable component 204 is unwound from the roller 202, as the coiling layers formed by the output loops decreases in number and the stacking layers formed by the receiving loops increases in number, the output lever arm is shortened gradually, and the receiving lever arm is elongated gradually. In contrast, while the extendable component 204 is wound onto the roller 202, as the coiling layers formed by the output loops increases in number and the stacking layers formed by the receiving loops decreases in number, the output lever arm is elongated gradually, and the receiving lever arm is shortened gradually. During extending or retracting of the extendable component 204, the elastic torque varies with the transmission lever arms while being transmitted via the transmission cord 133, so that the elastic force acting on the roller 202 increases as a released length of the extendable component 204 increases, and decreases as the released length decreases. Accordingly, the upward force applied by the roller 202 to the extendable component 204 also increases as the released length increases, and decreases as the released length decreases.

In the present embodiment, the window shade 200 is in the form of a roller shade, so that the downward force acting upon the roller 202 increases with the released length of the extendable component 204. Since the variation trend of the upward force versus the released length of the extendable component 204, is set to be generally identical to that of the downward force, the upward force can be set such that an absolute value of a difference of the upward force and the downward force is constantly smaller than system’s a maximum static friction. The mentioned system’s maximum static friction includes the maximum static friction generated between any two components of the window shade 200 that are in contact. With this configuration, once the external force, which is exerted by the user on the extendable component 204, is removed, the roller 202 stops moving immediately to halt the extendable component 204 at the current height.

In the present embodiment, the receiving slot 1321 of the receiving reel 132, and the output slot 1311 of the output reel 131, are both configured to restrict the transmission cord 133 such that after winding one turn thereon, the transmission cord 133 would be stacked to the next layer, but are not limited thereto. It is defined herein that the transmission cord 133 is restricted by the receiving slot 1321 such that after winding X turns on the receiving reel 132, the transmission cord 133 is stacked onto a subsequent layer, and, after winding Y turns on the output reel 131, the transmission cord 133 is stacked onto a succeeding layer. The values including X, the number of the stacking layers formed by the receiving loops that are stacked on the receiving reel 132, Y, and the number of the coiling layers formed by the output loops that are stacked on the output reel 131, all can be varied in accordance with the specification of the window shade to which the balancing drive system is applied, such as width, drop and weight of the material. Preferably, X is one of 1, 2, and 3. Preferably, Y is one of 1, 2, and 3.

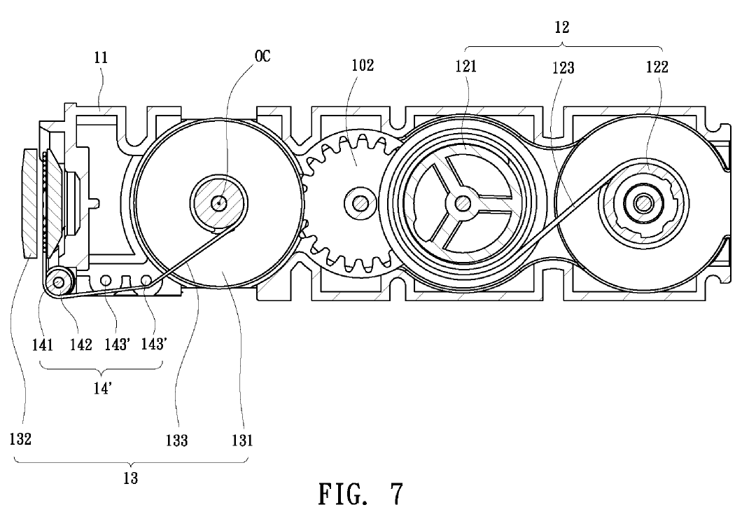

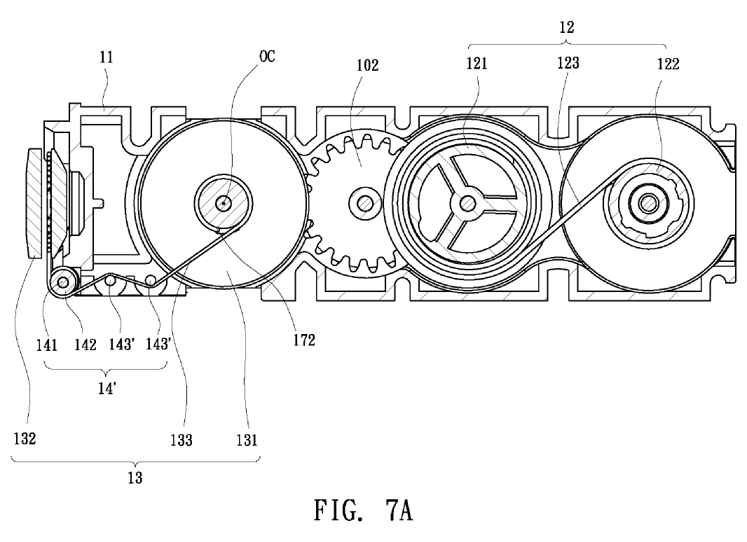

Please refer to FIGS. 7 and 7A, which show another variant of the friction member of the balancing drive system in the present embodiment. Currently, the roller shades on markets and their extendable components have various specifications. The above-mentioned adjustment of the loops in number as well as the stacking configuration of the loops in number can hardly fulfill all requirements in practice. For example, if a roller shade is manufactured as having insufficient system’s maximum static friction, an unpredictable movement of the extendable component may occur even when the roller shade is not being operated. For solving such a problem, in addition to the metal shaft pin 141 and the roller 142, the friction member 14’ of the present variant further includes two shaft pins 143’, which are disposed on the base 11, parallel to the output-center axis OC, and close to the output reel 131. According to the required magnitude of the frictional resistance, the transmission cord 133 can be selectively configured as going around only one of the shaft pins 143’ or both the two shaft pins 143’. Regarding the present variant of the friction member 14’, the frictional resistance decreases if the transmission cord 133 goes around only one of the shaft pins 143’ and contacts a part of it, as shown in FIG. 7. In contrast, the frictional resistance increases if the transmission cord 133 goes around both the two shaft pins 143’ as contacting a part of each of them, as shown in FIG. 7A. However, the manner that the transmission cord is interfered by the friction member is not limited thereto. In some other embodiments, the transmission cord may surround an entire turn on one of the shaft pins, whereby the frictional resistance increases more.

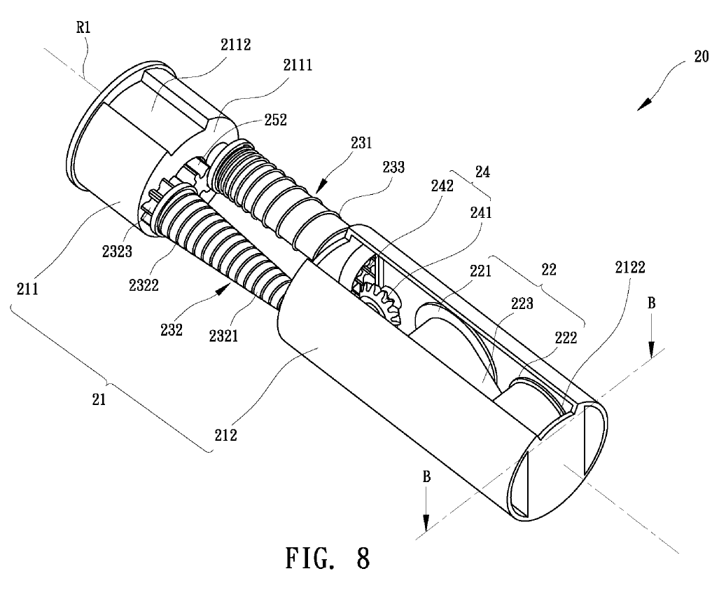

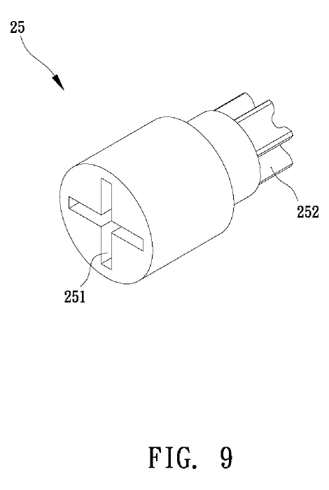

Please refer to FIGS. 8-10, which show another variant of the balancing drive system of the window shade 200 of the first embodiment. Please refer together with FIGS. 1 and 2 while reading the following description. The balancing drive system 20 includes a base 21, a power assembly 22, an adjusting assembly 23, a friction member 24, a fixed axle 25, and a transmission component 26. One end of the fixed axle 25 has a fixing groove 251 (see FIG. 9) engaged with the tongue 2051 of the first bracket 205, so that the fixed axle 25 is non-rotatably connected to the first bracket 205. The other end of the fixed axle 25 extends into the chamber of the roller 202 and has a fixed-splined shaft portion 252 thereon. The base 21 includes a first-base part 211 and a second-base part 212 that are disposed within the chamber of the roller 202 and spaced apart from each other. The first-base part 211 is rotatably sleeved on the fixed axle 25, and plugged into one end of the roller 202. Meanwhile, the first-base part 211 has a first end face 2111 and an engaging groove 2112 engaged with the inner circumferential edge of the roller 202. The second-base part 212 has a second end face 2121 and an engaging notch 2122, in which the second end face 2121 faces the first end face 2111, and the engaging notch 2122 is engaged with the inner circumferential edge of the roller 202. With the above configuration, the first-base part 211 and the second-base part 212 are both rotatable with the roller 202.

Keep referring to FIGS. 8-10. The power assembly 22 of the balancing drive system 20 includes a rotary-drive member 221, a spring-storage wheel 222, and a coil spring 223. The rotary-drive member 221 and the spring-storage wheel 222 are both rotary wheels rotatably disposed inside the second-base part 212 of the base 21. The two ends of the coil spring 223 are fixed on the rotary-drive member 221 and the spring-storage wheel 222, respectively. As the rotary-drive member 221 rotates in the different directions, the coil spring 223 is unwound from the spring-storage wheel 222 and wound onto the rotary-drive member 221, or alternatively, unwound from the rotary-drive member 221 and wound onto the spring-storage wheel 222.

Continue referring to FIGS. 8-10. The adjusting assembly 23 of the balancing drive system 20 includes an output reel 231, a receiving reel 232, and a transmission cord 233. The output reel 231 and the receiving reel 232 both have roughly elongated shapes, being disposed between the first end face 2111 of the first-base part 211 and the second end face 2121 of the second-base part 212, and parallel to each other. The output reel 231 is rotatable around an output-center axis OC’ relative to the base 21, and includes a straight cylinder. The receiving reel 232 is rotatable around a receiving-center axis RC’ relate to the base 21, and includes a conical cylinder 2321, a receiving slot 2322, and a gear portion 2323, in which the receiving slot 2322 extends helically along and on the conical cylinder 2321, and the gear portion 2323 is connected to the conical cylinder 2321 and engaged with the fixed-splined shaft portion 252. The output-center axis OC’ and the receiving-center axis RC’ are both parallel to the rotational axis of the roller 202, i.e., the first axis R1. The transmission cord 233 has a first end fixed on the receiving slot 2322 of the receiving reel 232 and a second end fixed on the output reel 231, in which the fixed position of the second end of the transmission cord 233 on the receiving reel 232 is closed to the small-radius end SE of the conical cylinder 2321. The transmission cord 233 is wound on the receiving reel 232 along the receiving slot 2322 and/or directly wound on the straight cylinder of the output reel 231. Meanwhile, the transmission cord 233 remains in a taut state constantly.

Referring to FIGS. 8-10 continuously, the transmission component 26 of the balancing drive system 20 is rotatably disposed inside the second-base part 212 of the base 21, and includes a transmission gear 261, which is engaged with the rim teeth of the rotary-drive member 221 of the power assembly 22. In this embodiment, the friction member 24 of the balancing drive system 20 is a pair of bevel gears engaged with each other, and the pair of bevel gears includes a first bevel gear 241 and a second bevel gear 242. The first bevel gear 241 is integrally connected with the transmission component 26 to be drivingly connected to the rotary-drive member 221, and the second bevel gear 242 is integrally connected with an end of the output reel 231 that is connected to the second-base part 212. When one of the first bevel gear 241 and the second bevel gear 242 is driven by the other to rotate or tend to rotate, a frictional resistance is generated between the first bevel gear 241 and the second bevel gear 242. Through the friction member 24 and the transmission component 26, the output reel 231 of the adjusting assembly 12 is drivingly connected to the rotary-drive member 221 of the power assembly 22, thereby being subjected to an elastic torque substantially continuously. The elastic torque is further transmitted, via the transmission component 26, the friction member 24, the output reel 231, the transmission cord 233, and the receiving reel 232 sequentially, thereby applying an elastic force to the roller 202. Accordingly, the roller 202 exerts an upward force in the vertical direction on the extendable component 204.

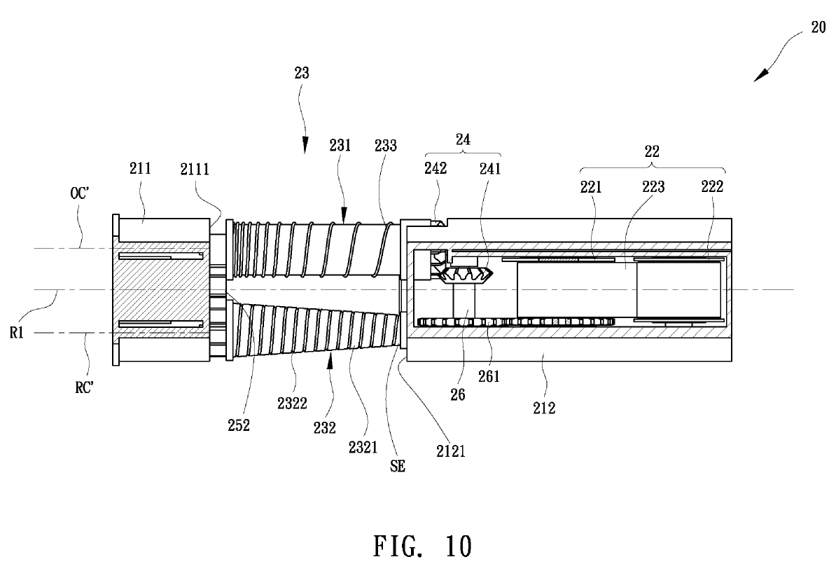

The acting manners of the balancing drive system 20 when being applied to the window shade 200, as shown in FIGS. 1 and 2, are illustrated herein. Please refer to FIGS. 8 and 10, with additional reference to FIGS. 1 and 2. When the user operates the window shade 200 to extend, which causes the roller 202 to rotate in the first direction D1, the roller 202 drives the first-base part 211 and the second-base part 212 of the base 21 to rotate together. Meanwhile, the gear portion 2323 of the receiving reel 232 of the adjusting assembly 23 rolls along the contour of the fixed-splined shaft portion 252 of the fixed axle 25, in which a reaction force exerted by the fixed-splined shaft portion 252 on the gear portion 2323 causes a torque on the receiving reel 232, thereby causing the receiving reel 232 to rotate around the receiving-center axis RC’ relative to the base 21. As a result, the transmission cord 233 is pulled out of the output reel 231, and wound on the receiving reel 232 along the receiving slot 2322 successively, thereby forming multiple receiving loops. Since the receiving slot 2322 is distributed helically on the conical cylinder 2321 as well as the second end of the transmission cord 233 fixed on the receiving reel 232 is close to the small-radius end SE of the conical cylinder 2321, the radii of the receiving loops continuously increase during winding. Moreover, at this moment, a cord tension torque, which is applied by the transmission cord 233 to the output reel 231, is greater than the elastic torque applied by the power assembly 22 to the output reel 231. Thus, the output reel 231 rotates in a pulling direction of the transmission cord 233, and drives the rotary-drive member 221 to rotate. Upon the rotation of the rotary-drive member 221, the coil spring 223 is unwound from the spring-storage wheel 222 and wound onto the rotary-drive member 221 to accumulate energy.

On the other hand, when the user operates the window shade 200 to retract, which causes the roller 202 to rotate in the second direction D2, the cord tension of the transmission cord 233 reduces, causing the coil spring 223 to unwind from the rotary-drive member 221 and thereby release the accumulated energy. Thus, the rotary-drive member 221 is driven to rotate reversely and drives the output reel 231 to rotate, such that the transmission cord 233 is pulled out of the receiving slot 2322 of the receiving reel 232, and wound back onto the straight cylinder of the output reel 231, thereby forming multiple output loops. As being pulled and dragged by the transmission cord 233, the receiving reel 232 rotates around the receiving-center axis RC’ relative to the base 21 again. Meanwhile, the gear portion 2323 rolls along the contour of the fixed-splined shaft portion 252, causing the first-base part 211 and the second-base part 212 to actuate the roller 202, so that the roller 202 rotates around the first axis R1 in the second direction D2 relative to the fixed axle 25 for retracting the extendable component 204 upward. While the transmission cord 233 is unwound along the receiving slot 2322 from the receiving reel 232 with each turn, the radii of the receiving loops continuously decrease.

With the above-mentioned configuration, while the extendable component 204 is unwound from the roller 202, the receiving level arm of the balancing drive system 20 is elongated gradually as the released length of the extendable component 204 increases. In contrast, while the extendable component 204 is wound onto the roller 202, the receiving level arm is shortened gradually as the released length decrease. While extending or retracting of the extendable component 204, the elastic torque varies with the transmission level arm while being transmitted via the transmission cord 233, so that the elastic force acting on the roller 202 increases as a released length of the extendable component 204 increases, and decreases as the released length decreases. Accordingly, the upward force applied by the roller 202 to the extendable component 204 also increases as the released length increases, and decreases as the released length decreases. The upward force is used to roughly balance the downward force applied by the weight of the extendable component 204 to the roller 202. By doing so, the window shade 200 can remain stationary while not being subjected to any external force. Furthermore, since the friction member 24 provides a frictional resistance to the roller 202, in the case that the upward force fails to completely balance the downward force, the tooth shape and material of the first bevel gear 241 and the second bevel gear 242 of the friction member 24 can be adjusted to amplify the frictional resistance, thereby ensuring the window shade 200 can stop immediately right after the external force is removed and stay still thereafter.

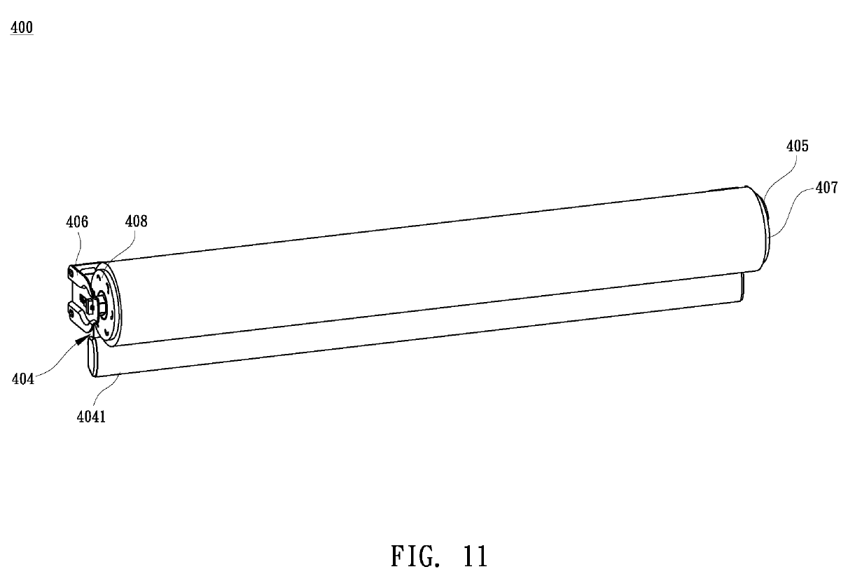

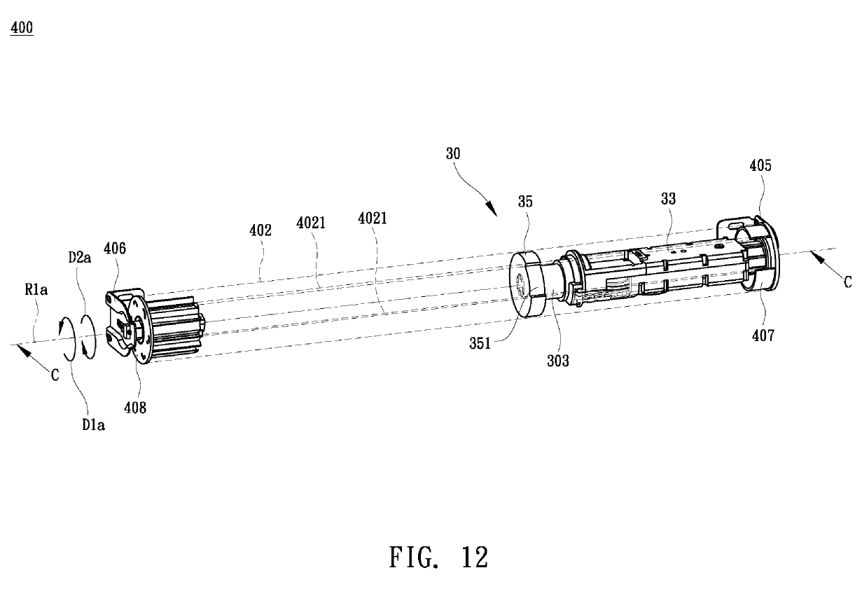

Please refer to FIGS. 11 and 12, which show the window shade according the second embodiment of the present disclosure. The window shade 400 is also a roller shade, including a roller 402, an extendable component 404, a first bracket 405, a second bracket 406, a first end plug 407, a second end plug 408, and a balancing drive system 30. The first bracket 405 and the second bracket 406 are secured on the architecture and spaced apart from each other. The first end plug 407 and the second end plug 408 are respectively plugged into two ends of the roller 402, and respectively engaged with the first bracket 405 and the second bracket 406, so that the roller 402 is disposed between the first bracket 405 and the second bracket 406 and is rotatable around the first axis R1a. The inner circumferential surface of the roller 402 are provided with two ribs 4021 protruding and extending longitudinally, thereby forming a non-circular inner circumferential edge of the roller 402.

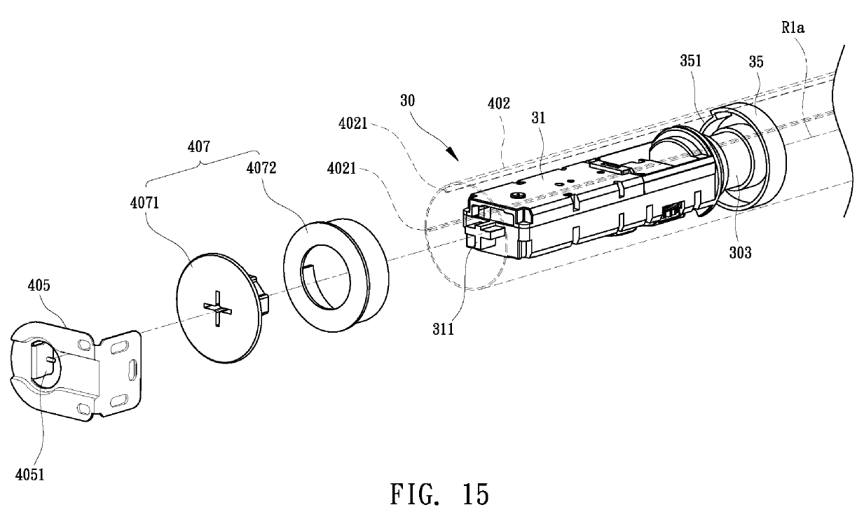

The window shade 400 mainly differs from the previous embodiment in structure and in acting manner of the balancing drive system 30, and the balancing drive system 30 is configured at a different relative position on the roller 402. Please refer to FIGS. 11-15. In the present embodiment, the balancing drive system 30 includes a base 31, a power assembly 32, an adjusting assembly 33, a friction member 34, and a rotary-transmission member 35. One side of the base 31 is provided with a coupling protrusion 311. Meanwhile, the first end plug 407 includes a fixed plugger 4071 and a rotary plugger 4072 rotatably sleeved thereon, in which the fixed plugger 4071 is engaged with and fixedly connected to a tongue 4051 of the first bracket 405. The base 31 is fixedly connected to the first bracket 405 as the coupling protrusion 311 of the base 31 is engaged with the fixed plugger 4071. As a result, the base 31 is disposed within the chamber of the roller 402 and is non-rotatable relative to the first bracket 405.

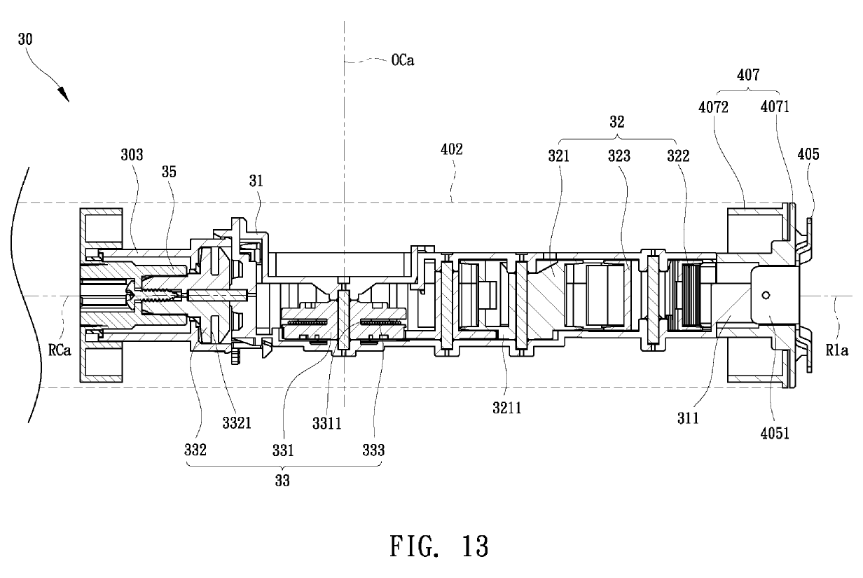

The rotary-transmission member 35 includes a wide-radius portion and a narrow-radius portion. Referring to FIG. 12, the wide-radius portion of the rotary-transmission member 35 has an engaging-concave portion 351 engaged with the inner circumferential edge of the roller 402. Referring to FIG. 13, the narrow-radius portion of the rotary-transmission member 35 is sleeved on and securely connected with a connecting shaft of the receiving reel 332. Moreover, an inner wall of the narrow-radius portion is engaged with the multiple coupling ribs formed on the connecting shaft of the receiving reel 332 to prevent relative rotation between the rotary-transmission member 35 and the receiving reel 332. With this configuration, while the rotary-transmission member 35 rotates together with the roller 402, the rotary-transmission member 35 further drives the receiving reel 332 to rotate around the receiving-center axis RCa relative to the base 31. Preferably, the balancing drive system 30 further includes a protecting sleeve 303, which is fixedly connected with the base 31 and covers the receiving reel 332 and the rotary-transmission member 35 but would not rotate with the rotary-transmission member 35 and the receiving reel 332. In the present embodiment, the rotary-transmission member 35 and the receiving reel 332 are presented as two independent components and non-rotatable with each other after being assembled, but are not limited thereto. In some other embodiments, the rotary-transmission member and the receiving reel are integrally formed into a one-piece component. In some other embodiments, the protecting sleeve and the base are integrally formed into a unitary component, and can still achieve the function of covering and protecting the rotary-transmission member and the receiving reel.

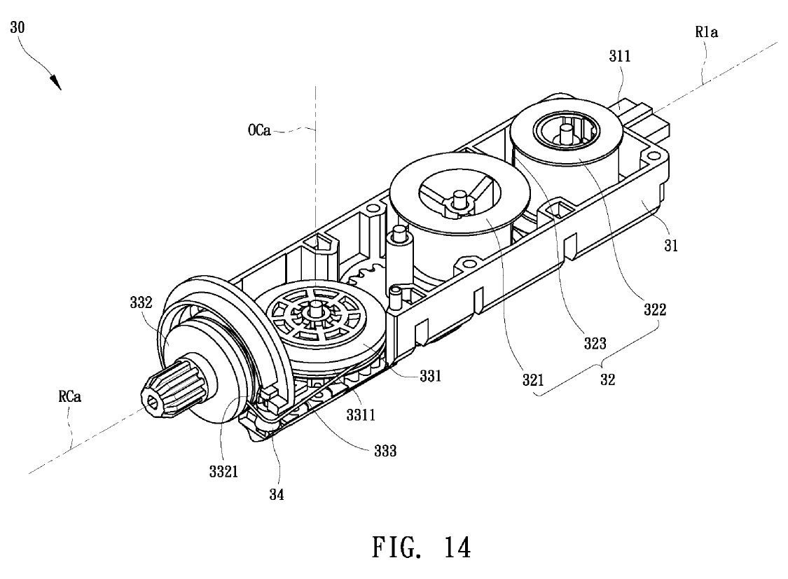

Furthermore, with reference to FIG. 14, the power assembly 21, the adjusting assembly 33, and the friction member 34 of the balancing drive system 30 are similar to those of the balancing drive system 10 shown in FIG. 5 in structure, so are not repeatedly illustrated below.

Please refer to FIGS. 11-14. In the present embodiment, to operate the window shade 400, the user moves the lower rail 4041 by hand to exert an external force on the extendable component 404. If the user moves down the lower rail 4041, the external force causes the extendable component 404 to extend downward and unwind from the roller 402, which drives the roller 402 to rotate in a first direction D1a. The rotary-transmission member 35 of the balancing drive system 30 is actuated by the roller 402 to rotate, thereby driving the receiving reel 332 to rotate around a receiving-center axis RCa relative to the base 31. As a result, the transmission cord 333 is pulled out of an output slot 3311 of the output reel 331, and wound on a receiving slot 3321 of the receiving reel 332 successively to form multiple receiving loops. A size of the width of the receiving slot 3321 restricts the transmission cord 333 such that after winding one turn on the receiving slot 3321, the transmission cord 333 is stacked onto the subsequent layer, resulting in the receiving loops stacked on one another and centered on the slot bottom of the receiving slot 3321 to form multiple stacking layers, and the radii of the receiving loops increase with each turn during winding.

In contrast, if the user moves up the lower rail 4041, the external force exerted by the user on the extendable component 404 counteracts the load of the roller 402, thereby reducing the cord tension of the transmission cord 333. As a result, the output reel 331 rotates reversely under the elastic torque of the power assembly 32, such that the transmission cord 333 is pulled out of the receiving slot 3321 of the receiving reel 332, and wound on the output slot 3311 of the output reel 331 successively to form multiple output loops. Concurrently, as being pulled and dragged by the transmission cord 333, the receiving reel 332 rotates around the receiving-center axis RCa relative to the base 31, and further drives the rotary-transmission member 35 to actuate the roller 402, so that the roller 402 rotates in a second direction D2a opposite to the first direction D1a and retracts the extendable component 404 upward. A size of the width of the output slot 3311 restricts the transmission cord 333 such that after winding one turn on the output slot 3311, the transmission cord 333 is stacked onto a successive layer. As a result, the output loops are stacked on one another and centered on the slot bottom of the output slot 3311 to form multiple coiling layers, and the number of the coiling layers increases with an increase of the output loops in number, so that the radii of the output loops increase with each turn during winding.

With the above-mentioned configuration, the elastic torque outputted by the power assembly 32 is transmitted to the roller 402 via the output reel 331, the transmission cord 333, the friction member 34, the receiving reel 332, and the rotary-transmission member 35 sequentially, so as to provide an elastic force to the roller 402. The elastic torque varies with the transmission lever arms while being transmitted via the transmission cord 133. In the present embodiment, the variation trend of the transmission lever arms is identical to that of the balancing drive system 10 in the previous embodiment. Therefore, the elastic force increases with an increase of the load of the roller 402 during extending of the window shade 400, and decreases with a decrease of the load of the roller 402 during retracting of the window shade 400. Further, since the variation trend of the elastic force is consistent with that of the load of the roller 402, the upward force applied by the roller 402 to the extendable component 404 also can be configured such that a difference of the upward force and a downward force, which is applied by the extendable component 404 to the roller 402, is constantly smaller than a system’s maximum static friction. The system’s maximum static friction includes the maximum static friction generated between any two components of the window shade 400 that are in contact. With this configuration, once the external force is removed, the roller 402 stops rotating immediately to halt the extendable component 404 at the current position. Additionally, if the system’s maximum static friction is insufficient, the number of the shaft pins (not shown) of the friction member 34 can be increased, thereby amplifying the frictional force provided by the friction member 34 to the roller 402, and enabling the roller 402 to stop rotating immediately once the external force is removed.

In the present embodiment, while the roller 402 rotates, the rotary-transmission member 35 and the receiving reel 332 both rotate with the roller 402 relative to the base 31, and the base 31 stays stationary in the meantime. In contrast, in the previous embodiment, while the roller 202 rotates, the base 11 is directly driven by the roller 202 to rotate relative to the receiving reel 132, and the receiving reel 132 concurrently stays stationary. Both these two variants of the balancing drive system provide variable elastic force to the roller. However, regarding the balancing drive system 30 according to the second embodiment, since the base 31 and the most of the components disposed thereon would not move in response to rotation of the roller 402 while the window shade 400 is being operated, the window shade 400 is less likely to shake during operation, in which the shaking may result in an inconsistent operating feel and noise.

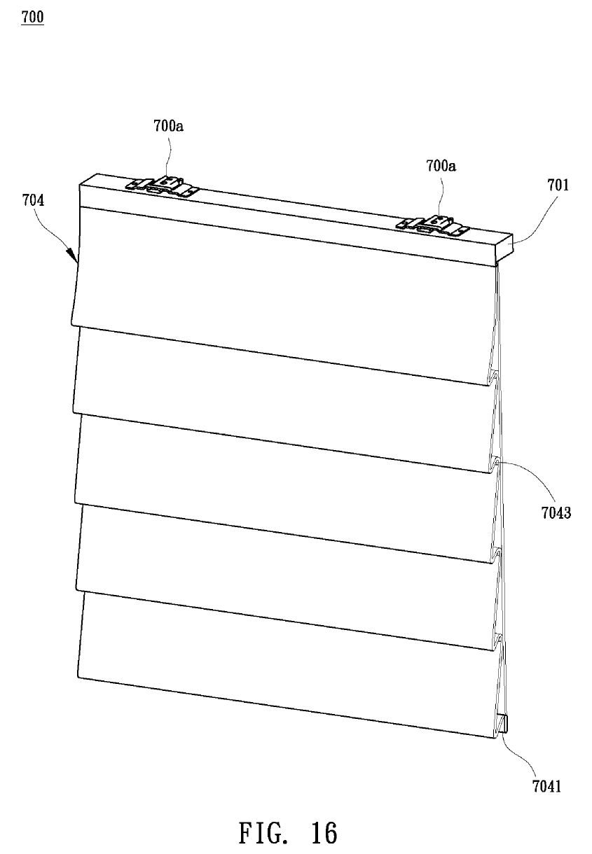

Please refer to FIGS. 16-18. According to the third embodiment of the present disclosure, the window shade 700 is a roman shade, including an upper rail 701, a roller 702, a shading structure 704, a first bracket 705, a second bracket 706, a first end plug 707, a second end plug 708, an extendable component 709, and a balancing drive system 60. The upper rail 701 is secured on the architecture through plural fixed brackets 700a. The first bracket 705 and the second bracket 706 are fixed on the upper rail 701 and arranged to correspond to two ends of the upper rail 701, respectively, as being spaced apart from each other and extending downward from the upper rail 701. The first end plug 707 and the second end plug 708 are respectively plugged into two opposite ends of the roller 702 and engaged with the first bracket 705 and the second bracket 706, thereby configuring the roller 702 to be rotatable around a first axis R1b relative to the upper rail 701. The inner circumferential surface of the roller 702 is provided with two ribs 7021 protruding and extending longitudinally to form a non-circular inner circumferential edge of the roller 702. Through connection between the first end plug 707 and the first bracket 705, the balancing drive system 60 is disposed within the chamber of the roller 702. The balancing drive system 60 provides an elastic force to the roller 702. Accordingly, the roller 702 exerts an upward force in the vertical direction on the extendable component 709. In the present embodiment, the upward force is used for winding and retracting the extendable component 709.

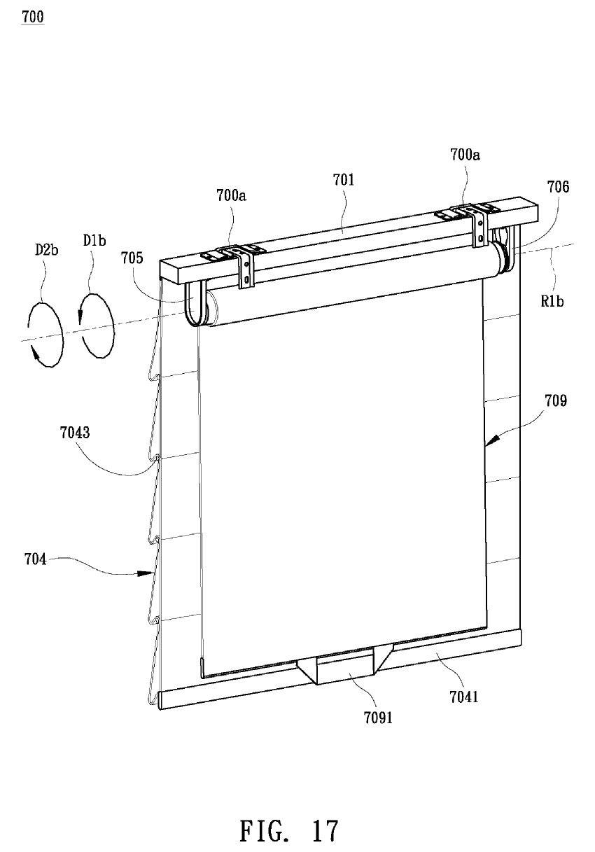

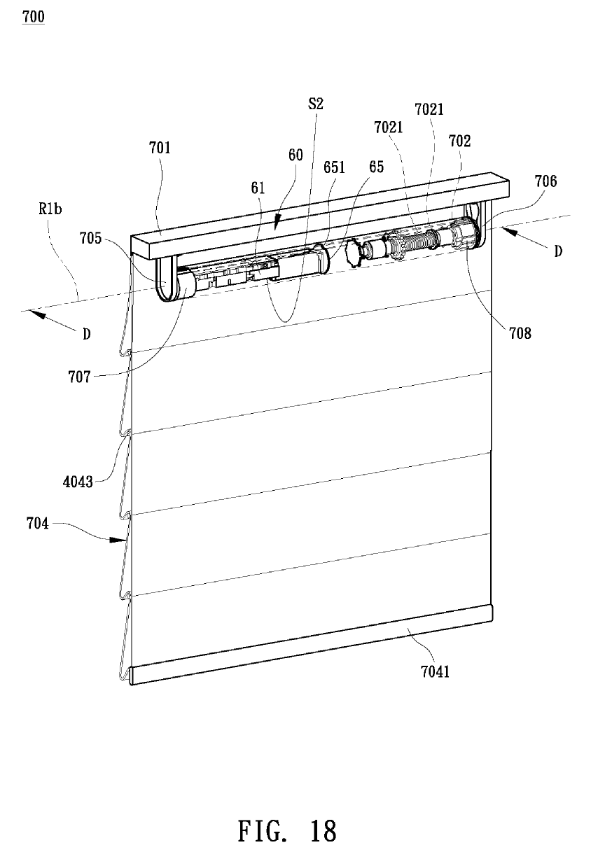

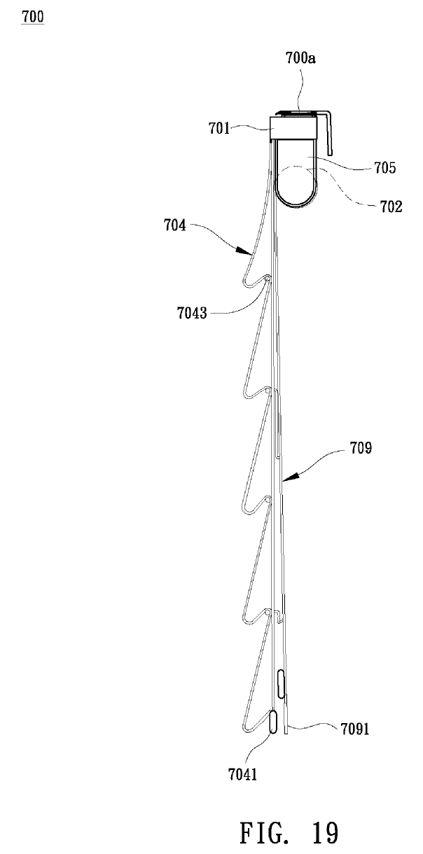

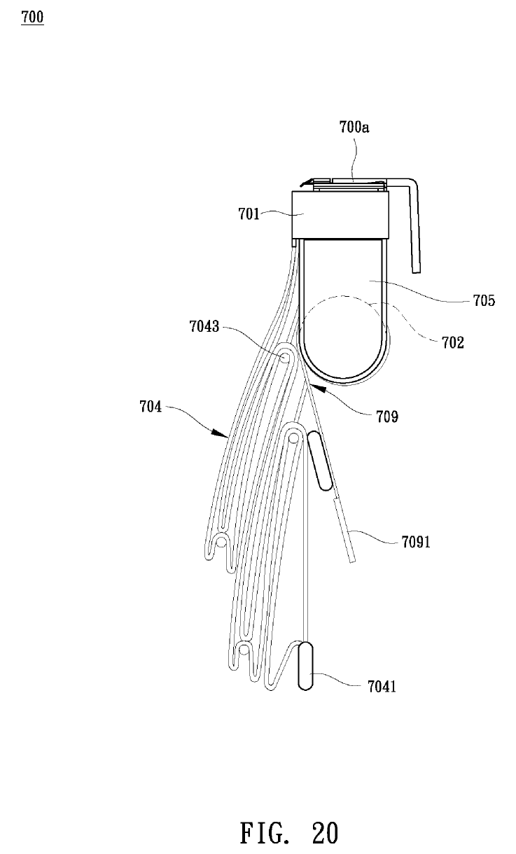

Please refer to FIGS. 19 and 20 with reference to FIGS. 17 and 18. The shading structure 704 has a top end edge connected to the upper rail 701 and a bottom end edge provided with a lower rail 7041. Between the top and bottom end edges, the shading structure 704 is further provided with multiple transverse shafts 7043 arranged along the vertical direction. The extendable component 709 is a flexible sheet material, such as a fabric piece. One end edge of the extendable component 709 is fixedly connected to the roller 702, and the other end edge is provided with a grip member 7091. The portion between the two end edges of the extendable component 709 hangs behind the shading structure 704 and is connected with the shading structure 704 through multiple connecting fabric pieces. To operate the window shade 700, the user stretches the hand to the rear of the shading structure 704 to pull down the grip member 7091 of the extendable component 709, by a short pull or a long pull, thereby exerting an external force on the extendable component 709 to cause subsequent actions of the window shade 700. More specifically, when the user pulls down the grip member 7091 continuously (i.e., the long pull), the extendable component 709 is continuously subjected to the external force in the downward direction, thereby extending downward and unwinding from the roller 702. The roller 702 is driven by the extendable component 709 to rotate in a first direction D1b. Concurrently, the extendable component 709 drives the shading structure 704 to unfold from top to bottom through the connecting fabric pieces. After the user finishes the long pull and stops exerting force, the roller 702 halts quickly as being locked by a locking mechanism (not shown) disposed within the second end plug 708, stopping the extendable component 709 from moving, and keeping the shading structure 704 with the current folded number when the external force is removed. By doing so, the user can adjust the folded extent of the shading structure 704 to adjust the shading area of the window shade 700.

On the other hand, when the user pulls down the grip member 7091 in a rapid, short manner (i.e., the short pull), the extendable component 70 causes the locking mechanism (not shown) to unlock the roller 702 in response to the short, rapid external force acting thereupon. Under the elastic force provided by the balancing drive system 60, the unlocked roller 702 rotates in a second direction D2b opposite to the first direction D1b to wind up the extendable component 709. Concurrently, the extendable component 709 drives the shading structure 704 to fold from bottom to top until the shading structure 704 is fully-folded, as shown in FIG. 20. At that moment, the weight of the shading structure 704 is mostly applied to the extendable component 709, resulting in the load of the roller 702 reaching the maximum. In contrast, while the shading structure 704 unfolds, the weight of the shading structure 704 borne by the extendable component 709 gradually turns to be borne by the upper rail 701 where the shading structure 704 is connected with, resulting in reduction of the load of the roller 702. Due to the window shade 700 being a roman shade, as a released length of the extendable component 709 increases, a downward force exerted on the roller 702 by the combined weight of the extendable component 709 and the shading structure 704 decreases.

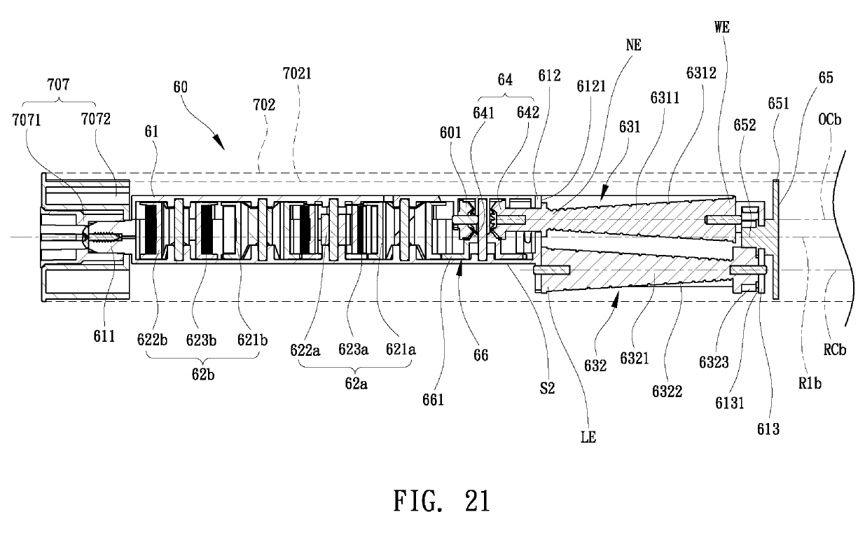

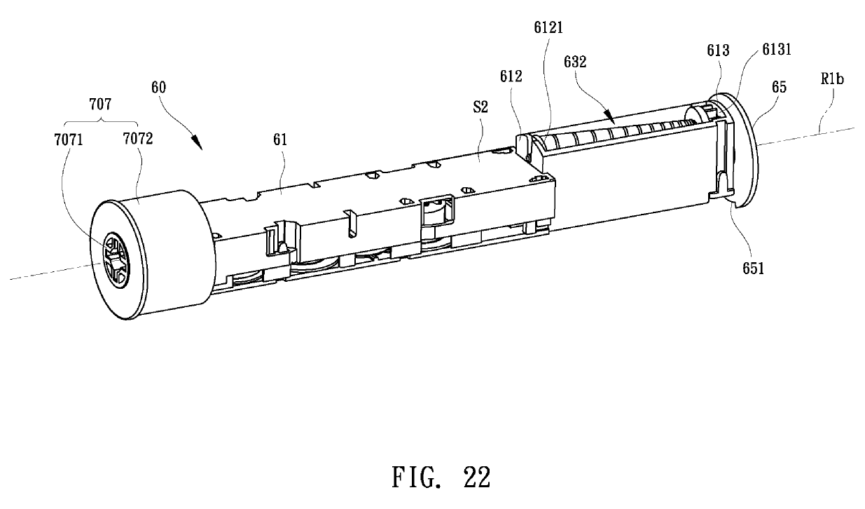

Please refer to FIG. 18, and refer together with FIGS. 21-23. The first end plug 707 includes a fixed shaft 7071 and an end-plug sleeve 7072. The fixed shaft 7071 is engaged with a tongue (not shown) of the first bracket 705 to be fixedly connected to the first bracket 705. The end-plug sleeve 7072 is rotatably sleeved on the fixed shaft 7071. The outer peripheral side of the end-plug sleeve 7072 is engaged with the inner circumferential edge of the roller 702, so that the end-plug sleeve 7072 is rotatable with the roller 702. The balancing drive system 60 includes a base 61, a first power assembly 62a, a second power assembly 62b, an adjusting assembly 63, a friction member 64, a rotary-transmission member 65, and a transmission component 66. One side of the base 61 is provided with a connecting pin 611. The connecting pin 611 is inserted into and securely connected with the fixed shaft 7071 of the first end plug 707. Thus, the base 61 is disposed within the chamber of the roller 702 in a fixed manner. Moreover, the outer peripheral surface of the connecting pin 611 is engaged with the inner wall of the fixed shaft 7071 to ensure the base 61 is non-rotatable relative to the fixed shaft 7071 and the first bracket 705. In addition, the base 61 includes a first side wall 612 and a second side wall 613, which have a first end face 6121 and a second end face 6131 thereon respectively, and the first end face 6121 and the second end face 6131 face each other. The rotary-transmission member 65 includes an engaging-concave portion 651 engaged with the inner circumferential edge of the roller 702, so that the rotary-transmission member 65 is rotatable with the roller 702. Furthermore, one end of the rotary-transmission member 65 extending into the base 61 has a transmission-splined shaft portion 652 thereon.

Please continue referring to FIGS. 21-23. In the present embodiment, the adjusting assembly 63 of the balancing drive system 60 includes an output reel 631, a receiving reel 632, and a transmission cord 633. The output reel 631 and the receiving reel 632 include a tapered cylinder 6311 and a conical cylinder 6321 respectively, which are extending in the opposite tapered directions and disposed between the first end face 6121 and the second end face 6131 that face each other, and respectively have an output slot 6312 and a receiving slot 6322 helically distributed thereon. The output reel 631 is rotatable around an output-center axis OCb relative to the base 61, and the tapered cylinder 6311 of the output reel 631 has a wide end WE and a narrow end NE. The receiving reel 632 is rotatable around a receiving-center axis RCb relative to the base 61. The output-center axis OCb and the receiving-center axis RCb are both parallel to the rotational axis of the roller 702, i.e., the first axis R1b. The receiving reel 632 further has a gear portion 6323 connected with one end of the conical cylinder 6321 and engaged with the transmission-splined shaft portion 652 of the rotary-transmission member 65. The transmission cord 633 has a first end fixed on the output reel 631 and a second end fixed on the receiving reel 632. The fixed positions of the first and second ends of the transmission cord 633 are close to the wide end WE of the tapered cylinder 6311, and a large-radius end LE of the conical cylinder 6321, respectively. The transmission cord 633 is wound on the output reel 631 along the output slot 6312 and/or wound on the receiving reel 632 along the receiving slot 6322. Meanwhile, the transmission cord 633 constantly remains in a taut state.

Please refer to FIGS. 21-23. The first and second power assemblies 62a, 62b are disposed within the base 61, and their structures and acting principles are similar to those of the power assembly 32 of the balancing drive system 30 according to the second embodiment of the present disclosure (see FIG. 14). The first and second power assemblies 62a, 62b are each composed of a respective rotary-drive member 621a, 621b, a respective spring-storage wheel 622a, 622b, and a respective coil spring 623a, 623b. Nevertheless, the first and second power assemblies 62a, 62b are drivingly connected to each other, because the above-mentioned rotary wheels are engaged with one another by their rim teeth. The transmission component 66 is rotatably disposed within the base 61, having a transmission gear 661 engaged with the rim teeth of the rotary-drive member 621a of the first power assembly 62a. The friction member 64 of the balancing drive system 60 is a pair of bevel gears engaged with each other, including a first and second bevel gear 641, 642. The first bevel gear 641 is fixed on the transmission component 66 to be drivingly connected with the rotary-drive member 621a of the first power assembly 62a. The second bevel gear 642 is integrally formed with the end of the output reel 631 connected to the first side wall 612. With the above configuration, the output reel 631 of the adjusting assembly 63 is drivingly connected to the first power assembly 62a via the friction member 64 and the transmission component 66, so that the output reel 631 is subjected to an elastic torque collectively outputted by the first and the second power assemblies 62a, 62b. When the first and the second power assemblies 62a, 62b of the friction member 64 rotate or tend to rotate, a frictional resistance is generated and provided to the roller 702. Moreover, the tooth shape and material of the first and second bevel gears 641, 642 of the friction member 64 can be adjusted to alter the magnitude of the frictional resistance.

The elastic force is transmitted to the roller 702 via the transmission component 66, the friction member 64, the output reel 631, the transmission cord 633, the receiving reel 632, and the rotary-transmission member 63 sequentially, thereby exerting an elastic force on the roller 702. Accordingly, the roller 702 exerts the upward force on the extendable component 709. Preferably, the balancing drive system 60 further includes a balancing-bevel gear 601 disposed on the base 61 and located on the opposing side to the second bevel gear 642. The disposition of the balancing-bevel gear 601 maintains the balance of the transmission component 66 during force transmission, and enhances stability of the force transmission. When utilizing the same coil springs, the elastic torque collectively outputted by the first and second power assemblies 62a, 62b would be greater than that solely outputted by the power assembly 32 of the balancing drive system 30 in the second embodiment, as shown in FIG. 14. In other words, regarding the window shade of the present disclosure, the number of the power assemblies of the balancing drive system can be varied according to the hardware specification of the extendable component as the multiple power assemblies can be linked in series to amplify the magnitude of the elastic force acting on the roller.

Please refer to FIGS. 21-23 together with FIGS. 17 and 18. When the user operates the window shade 700 to exert the external force on the extendable component 709 by which the roller 702 rotates in the first direction D1b, the rotary-transmission member 65 drives the receiving reel 632 of the adjusting assembly 63 to rotate around the receiving-center axis RCb, through the engagement of the transmission-splined shaft portion 652 and the gear portion 6323. As a result, the transmission cord 633 is pulled out of the output reel 631, and wound on the conical cylinder 6321 along the receiving slot 6322 successively. On the other hand, when the user operates the window shade 700 to exert the external force on the extendable component 709 by which the roller 702 rotates in the second direction D2b, the cord tension of the transmission cord 633 reduces, resulting in the output reel 631 of the adjusting assembly 63 rotating under the effect of the elastic torque, which is collectively outputted from the first and second power assemblies 62a, 62b. Thus, the transmission cord 633 is pulled out of the receiving slot 6322 of the receiving reel 632, and wound on the output reel 631 along the output slot 6312 successively to form multiple output loops. As being pulled and dragged by the transmission cord 633, the receiving reel 632 rotates around the receiving-center axis RCb relative to the base 61, and the gear portion 6323 rolls along the contour of the transmission-splined shaft portion 652, which causes the rotary-transmission member 65 to rotate, thereby actuating the roller 702 to rotate in the second direction D2b to wind up and retract the extendable component 709.

In the present embodiment, the balancing drive system 60 is applied to a roman shade. Therefore, the transmission cord 633 of the adjusting assembly 63 is configured as the fixed positions of its first and second ends, which are respectively on the output reel 631 and the receiving reel 632, are close to the wide end WE of the tapered cylinder 6311 and the large-radius end LE of the conical cylinder 6321, respectively. Thus, during operation of the window shade 700, the receiving loops gradually decrease in radius while winding, and so do the output loops. In other words, the variation trends of the receiving and output level arms versus a released length of the extendable component 709 are opposite to those in the previous embodiments. More specifically, regarding the window shade 700 of the present disclosure, while the extendable component 709 is unwound from the roller 702, as the released length of the extendable component 709 increases, the output level arm of the balancing drive system 60 is elongated gradually and the receiving level arm is shortened gradually. In contrast, while the extendable component 709 is wound onto the roller 702, as the released length of the extendable component 709 decreases, the output level arm of the balancing drive system 60 is shortened gradually and the receiving level arm is elongated gradually. With this configuration, the elastic torque varies with the transmission level arms while being transmitted via the transmission cord 633, so that the elastic force provided by the balancing drive system 60 to the roller 702 decreases as the released length of the extendable component 709 increases. Therefore, the upward force exerted on the extendable component 709 by the roller 702 has a variation trend versus the released length of the extendable component 709 consistent with that of the downward force, which is exerted on the roller 702 by the combined weight of the shading structure 704 and the extendable component 709.

In the present embodiment, the upward force is constantly greater than the sum of the downward force and the system’s maximum static friction, such that the roller 702 while not being locked by the locking mechanism (not shown in the figures) always winds up the extendable component 709. The above-mentioned system’s maximum static friction includes the maximum static friction generated between any two components of the window shade 700 that are in physical contact. In comparison with the conventional roman shades, the window shade 700 in the present embodiment has an advantage that the upward force can vary with the released length of the extendable component 709, and the variation trend of the upward force is consistent with that of the downward force exerted on the roller 702. Therefore, during continuous pulling of the extendable component 709 by the user, the net force must be overcome by the user remains generally constant regardless of the released length of the extendable component 709. Compared to a typical conventional roman shade, which becomes harder to pull as it is pulled downward, the window shade 700 requires the less operating force and provides smoother tactile feel during operation. Moreover, the friction member 64 provides a frictional resistance that is variable to the roller 702. In the case that the upward force exerted on the extendable component 709 by the roller 702 is so great that the speeds of winding up the extendable component 709 and folding up the shading structure 704 become too fast, the fictional resistance can be slightly amplified by an adjustment of the friction member 64, thereby achieving folding up the window shade 700 in a gentle manner.

Regarding the balancing drive systems 10, 30, 60 according to the first, second, and third embodiments of the present disclosure, the receiving and output lever arms are both variable level arms. However, if there is only one of the receiving and output lever arms being variable, the system can also function. For example, if the output slot 1311 of the output reel 131 of the balancing drive systems 10 in the first embodiment is modified to be wider, allowing the transmission cord 133 to be stacked on one another while the transmission cord 133 is wound thereon to form the multiple output loops, the output loops remain unchanged in radius during winding. Under this circumstance, the balancing drive system with only the receiving loops increasing or decreasing in radius in response to extending or retracting action of the extendable component 204 can still provide a variable elastic force to the roller 202. Another example is the balancing drive system 20 shown in FIG. 10, which has the output reel 231 including a straight cylinder without a cord slot. The transmission cord 233 could not stack on one another during winding thereon, so that the output loops remain unchanged in radius during winding or unwinding. Under this circumstance, only the receiving loops could increase or decrease in radius in response to extending or retracting of the extendable component 204. However, the balancing drive system 20 with this configuration can still provide a variable elastic force to the roller 202. Nevertheless, the elastic force provided by this configuration with only one variable level arm has a smaller variation range in comparison with that of the elastic force provided by the configuration with two variable level arms, which is applicable to the window shades that have wider sizes, shorter drops, or heavier materials.

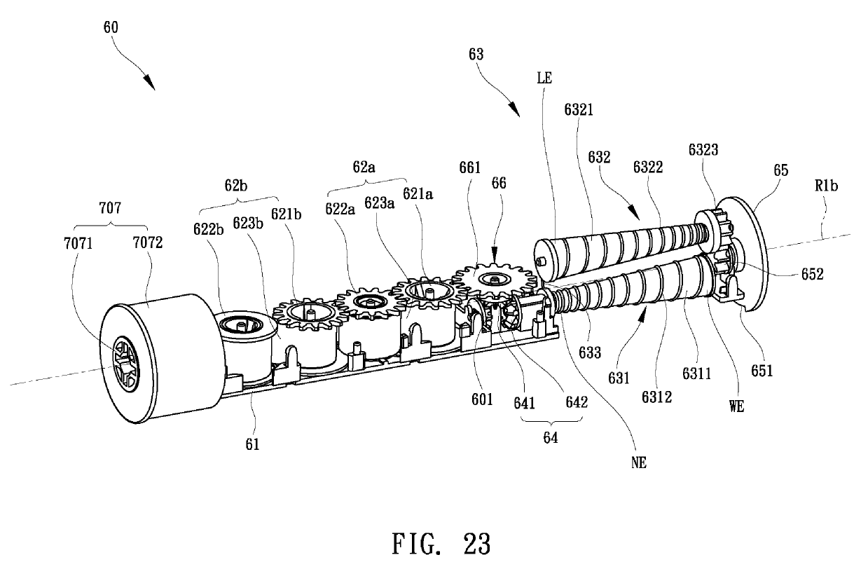

In addition, regarding the balancing drive system 20 shown in FIG. 10, its output reel can also be modified to include a tapered cylinder and an output slot helically distributed thereon, so that the balancing drive system could have two variable level arms to provide an elastic force with larger variation range. The above-mentioned tapered cylinder may be similar in structure to the tapered cylinder 6311 of the output reel 631 of the balancing drive system 60 according to the fourth embodiment (see FIG. 23), which has a wide end WE and a narrow end NE. In other words, the above-mentioned tapered cylinder may also have a wide end and a narrow end. However, the fixed position of the first end of the transmission cord on the output reel would be close to the narrow end of the tapered cylinder, thereby causing the output loops to gradually increase in radius during winding.

The following description in conjunction with the drawings more specifically describes how the upward force, which is provided to the roller by the balancing drive system of the window shade of the present disclosure, and the downward force acting on the roller, correspond to changes in a released length of the extendable component.

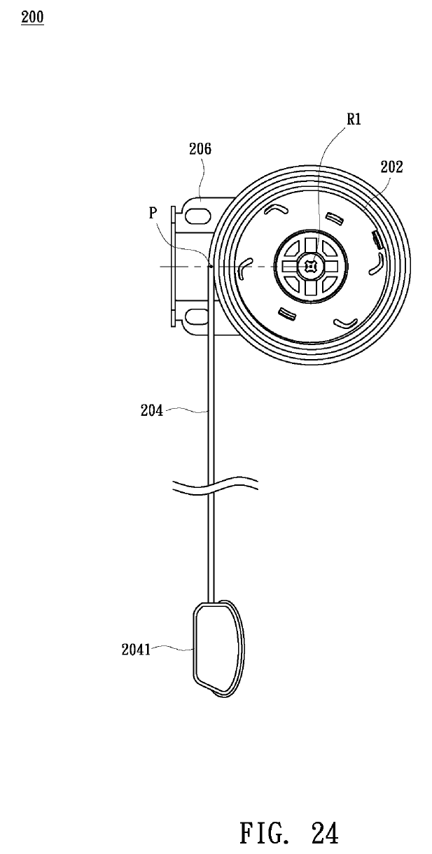

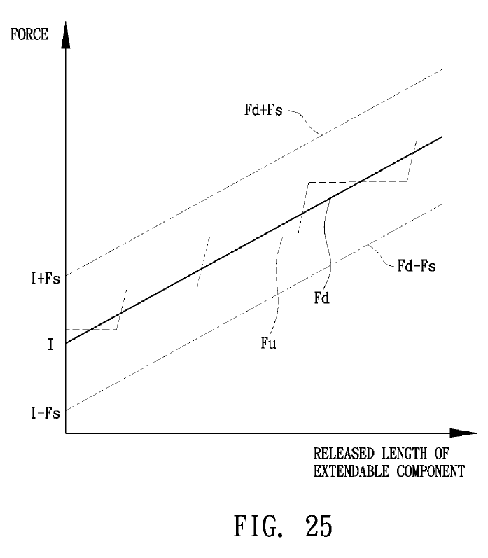

Please refer to FIGS. 24 and 25 together with FIGS. 1 and 2. The window shade 200 according to the first embodiment, as shown in FIGS. 1 and 2, is taken as an example herein. The balancing drive system 10 exerts an elastic force on the roller 202. Accordingly, the roller 202 exerts an upward force in the vertical direction on the extendable component 204 for balancing a downward force exerted on the roller 202 by the extendable component 204. As shown in FIG. 24, the upward force and the downward force may collectively act upon a position P on the extendable component 204 where the extendable component 204 leaves the roller 202 after unwinding. The downward force is transmitted to the roller 202 through the wound part of the extendable component 204 on the roller 202. In FIG. 25, Fu and Fd represent the magnitude of the upward force and the downward force, respectively, and an initial value I of Fd represents the magnitude of the force exerted on the roller 202 by the extendable component 204 when the extendable component 204 is fully wound on the roller 202 (roughly equals the weight of the lower rail 2041). While operating the window shade 200, the user exerts an external force on the extendable component 204 to change a released length of the extendable component 204, in which as the released length increases, Fd also increases. Fu is set to be positively correlated to the released length, thereby having a variation trend generally consistent with that of Fd. More specifically, Fu and the released length exhibit a stepwise positive correlation because the balancing drive system 10 adjusts the transmission level arms of the transmission cord 133 through a cord-stacking manner, in which the radii of the loops only increase when each time the loop is stacked onto the next layer during the transmission cord 133 is winding up to form the loops. When the external force is removed, an absolute value of a difference of Fu and Fd is ensured to be smaller than a system’s maximum static friction, so that the roller 202 can stop rotating immediately, and an unpredictable movement of the extendable component 204 is prevented. The above-mentioned system’s maximum static friction includes the maximum static friction generated between any two components of the window shade 200 that are in contact, and the system’s maximum static friction is opposite to a direction that the extendable component 204 tends to move at the moment. The system’s maximum static friction is represented by Fs in the figure.

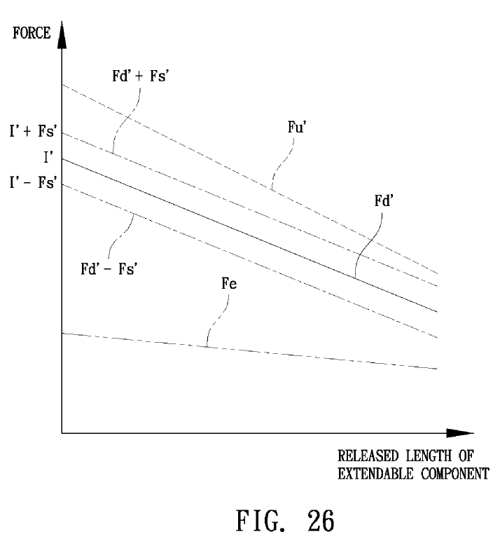

On the other hand, please refer to FIG. 26 together with FIGS. 17-20. The window shade 700 according to the third embodiment, as shown in FIGS. 17-20, is taken as an example herein. The balancing drive system 60 provides an elastic force to the roller 702. Accordingly, the roller 702 exerts an upward force in the vertical direction on the extendable component 709, which is represented by Fu’. The combined weight of the extendable component 709 and the shading structure 704 exerts a downward force on the roller 702, which is represented by Fd’. An initial value I’ of Fd’ represents the magnitude of the force exerted on the roller 702 by the extendable component 709 when the extendable component 709 is fully wound on the roller 702, as shown in FIG. 20 (roughly equals most of the weight of the shading structure 704 plus the weight of the grip member 7091). While operating the window shade 700, the user exerts an external force on the extendable component 709 to change a released length of the extendable component 709, in which as the released length increases, Fd’ decreases.

Please continue referring to FIG. 26 together with FIGS. 17-20. The window shade 700 has a system’s maximum static friction, which includes the maximum static friction generated between any two components of the window shade 700 that are in contact, and the system’s maximum static friction is opposite to a direction in which the extendable component 709 moves or tends to move currently. In FIG. 26, Fs’ represents the system’s maximum static friction. Fu’ is set to be constantly greater than the magnitude of a net force, which results from a sum of the downward force and the co-directional system’s maximum static friction, i.e., Fd’ + Fs’. Therefore, the roller 702 always winds up and retract the extendable component 709 while not being unlocked. Moreover, the balancing drive system 60 uses a helical-shaped slot formed on a conical structure to guide the winding path of the transmission cord 633. Thus, the transmission level arms are adjusted to configure Fu’ to have a variation trend negatively correlated to the released length of the extendable component 709, so that the variation trend of Fu’ becomes roughly consistent with that of Fd’. Therefore, as the released length of the extendable component 709 increases, a minimum external force required to be applied by the user to the extendable component 709 that can trigger it to move downward remains roughly the same or even slightly reduced. The magnitude of the minimum external force is represented by Fe, and Fe equals Fu’ minus the magnitude of a net force, which results from a sum of the downward force and the counter-directional system’s maximum static friction, i.e., Fd’ - Fs’. Under this circumstance, the configuration of the window shade 700 can solve the problem of the conventional roman blinds that the unchanged upward force would cause the user to pull harder as the blind is pulled downward.

The embodiments described above are only some exemplary embodiments of the present disclosure. All equivalent structures which employ the concepts disclosed in this specification and the appended claims should fall within the scope of the present disclosure.

The foregoing outlines the features of several embodiments, enabling those skilled in the art to fully appreciate the aspects of the present disclosure. Those skilled in the art should recognize that the present disclosure provides a foundation for designing or modifying other processes and structures to achieve substantially the same functions and/or substantially the same results as those of the embodiments introduced herein. Furthermore, such equivalent arrangements do not deviate from the spirit and scope of the present disclosure, and various changes, substitutions, and alterations may be made without so departing.

What is claimed is:

1. A window shade, comprising:
a roller, a first bracket and a second bracket, wherein the first bracket and the second bracket are disposed immovable relative to an architecture and spaced apart from each other; the roller is disposed between the first bracket and the second bracket, and is operable to rotatable around a first axis;
an extendable component, having one end edge connected to the roller so that the extendable component is configured to be wound onto or unwound from the roller; and
a balancing drive system, operatively connected to the roller, comprising:
a base, disposed to correspond to one end of the roller and disposed within a chamber of the roller;
a power assembly, disposed on the base, comprising:
a rotary-drive member, rotatably connected to the base; and
a coil spring, having one end connected to the rotary-drive member so that the coil spring is configured to be wound onto or unwound from the rotary-drive member according to a rotation direction of the rotary-drive member;
an adjusting assembly, comprising:
an output reel, connected to the base, rotatable around an output-center axis relative to the base, and drivingly connected to the rotary-drive member so that the output reel is subjected to an elastic torque substantially continuously provided by the coil spring;
a receiving reel, connected to the base and having a receiving-center axis parallel to the first axis, wherein the base and the receiving reel are configured to allow for a relative rotation therebetween; and
a transmission cord, having a first end and a second end fixed on the output reel and the receiving reel respectively, wherein the transmission cord is wound on at least one of the output reel and the receiving reel, and remains in a taut state; and
a friction member, directly or indirectly connected with the power assembly, and providing a frictional resistance to the roller;
wherein when the extendable component is operated by an external force to move, the extendable component is wound onto or unwound from the roller, wherein when the extendable component is unwound from the roller, the transmission cord is wound successively on the receiving reel to form plural receiving loops; when the extendable component is wound onto the roller, the transmission cord is wound successively on the output reel to form plural output loops; the plural receiving loops and/or the plural output loops are wound with radii thereof gradually varying correspondingly with a released length of the extendable component unwound from the roller.

2. The window shade of claim 1, wherein the friction member is disposed between the output reel and the receiving reel, and the transmission cord goes around and contacts the friction member.

3. The window shade of claim 2, wherein the friction member comprises at least one shaft pin disposed on the base and extending in a direction parallel to the output-center axis; the transmission cord has a portion located between the output reel and the receiving reel, and the portion is interfered by the at least one shaft pin to be bent; when the transmission cord moves or tends to move relative to the at least one shaft pin, the frictional resistance is generated between the transmission cord and the at least one shaft pin.

4. The window shade of claim 1, wherein the friction member is located between the power assembly and the adjusting assembly, and is drivingly connected to the output reel.

5. The window shade of claim 4, wherein the friction member comprises a pair of bevel gears engaged with each other; one of the bevel gears is drivingly connected to the output reel, and the other is drivingly connected to the rotary-drive member; when the output reel and the rotary-drive member rotate, the pair of bevel gears are driven to rotate and generate the frictional resistance.

6. The window shade of claim 1, wherein the balancing drive system further comprises a rotary-transmission member connected with the roller and rotatable together with the roller; the rotary-transmission member is drivingly connected to the receiving reel, so that the receiving reel can be driven by the rotary-transmission member to rotate around the receiving-center axis; the base is connected with the first bracket and immovable relative to the first bracket.

7. The window shade of claim 6, wherein the elastic torque is transmitted via the output reel, the friction member, the transmission cord, the receiving reel, and the rotary-transmission member to provide an elastic force to the roller; when the external force is removed, a load borne by the roller increases with the released length of the extendable component; the plural receiving loops and/or the plural output loops are wound with radii thereof gradually increasing as the released length of the extendable component increases, thereby increasing the elastic force acting on the roller as the load borne by the roller increases.

8. The window shade of claim 7, wherein the rotary-transmission member is fixedly connected with the receiving reel; the receiving reel comprises a receiving slot having an annular shape and centered on the receiving-center axis; the receiving slot restricts the transmission cord such that after winding X turns around the receiving reel, the transmission cord is stacked onto a subsequent layer, resulting in the receiving loops stacked on one another to form plural stacking layers when the extendable component is fully unwound form the roller, wherein X is one of 1, 2, and 3; while the extendable component is unwound from the roller and the transmission cord is wound onto the receiving reel, the stacking layers increase in number as the receiving loops increase in number, so that radii of the receiving loops gradually increase.

9. The window shade of claim 7, wherein the rotary-transmission member is fixedly connected with the output reel; the output reel has an output slot having an annular shape and centered on the output-center axis; the output slot restricts the transmission cord such that after winding Y turns around the output reel, the transmission cord is stacked onto a succeeding layer, resulting in the output loops stacked on one another to form plural coiling layers when the extendable component is fully wound on the roller, wherein Y is one of 1, 2, and 3; while the extendable component is wound onto the roller and the transmission cord is wound onto the output reel, the coiling layers increase in number as the output loops increase in number, so that radii of the output loops gradually increase.

10. The window shade of claim 7, wherein the rotary-transmission member has one end extending into the base and having a transmission-splined shaft portion thereon; wherein the receiving reel comprises:
a conical cylinder, centered on the receiving-center axis;
a receiving slot, extending helically along and on the conical cylinder; and
a gear portion, connected with the conical portion and engaged with the transmission-splined shaft portion;
wherein the second end of the transmission cord fixed on the receiving reel is close to a small-radius end of the conical cylinder; while the extendable component is unwound from the roller, the transmission cord is wound on the conical cylinder along the receiving slot, causing radii of the receiving loops to gradually increase during winding.

11. The window shade of claim 1, wherein the rotary-transmission member has one end extending into the base and having a transmission-splined shaft portion thereon; the receiving reel comprises a gear portion engaged with the transmission-splined shaft portion; wherein the output reel comprises:
a tapered cylinder, centered on the output-center axis; and
an output slot, extending helically along and on the tapered cylinder;
wherein the first end of the transmission cord fixed on the output reel is close to a narrow end of the tapered cylinder; when the extendable component is wound on the roller, the transmission cord is wound on the tapered cylinder along the output slot, causing radii of the output loops to gradually increase during winding.

12. The window shade of claim 6, further comprising:
an upper rail, fixedly disposed on the architecture, wherein the first bracket and the second bracket are fixedly disposed on the upper rail and spaced apart from each other, and the roller is rotatable around the first axis relative to the upper rail; and
a shading structure, having a top end edge connected to the upper rail; wherein the extendable component is connected with the shading structure, such that, while the extendable component is operated by the external force to wind on the roller, the extendable component drives the shading structure to fold successively from bottom to top, and, while the extendable component is operated by the external force to unwind from the roller, the extendable component drives the shading structure to unfold successively from top to bottom;
wherein the elastic torque is transmitted via the output reel, the transmission cord, the receiving reel, the friction member, and the rotary-transmission member to provide an elastic force to the roller; when the external force is removed, a load borne by the roller decreases with the released length of the extendable component; the plural receiving loops and/or the plural output loops are wound with radii thereof gradually decreasing as the released length of the extendable component increases, thereby reducing the elastic force acting on the roller as the load borne by the roller decreases.

13. The window shade of claim 12, wherein the rotary-transmission member has one end extending into the base and having a transmission-splined shaft portion thereon; wherein the receiving reel comprises:
a conical cylinder, centered on the receiving-center axis;
a receiving slot, extending helically along and on the conical cylinder; and
a gear portion, connected with the conical portion and engaged with the transmission-splined shaft portion;
wherein the second end of the transmission cord fixed on the receiving reel is close to a large-radius end of the conical cylinder; while the extendable component is unwound from the roller, the transmission cord is wound on the conical cylinder along the receiving slot, causing radii of the receiving loops to gradually decrease during winding.

14. The window shade of claim 12, wherein the rotary-transmission member has one end extending into the base and having a transmission-splined shaft portion thereon; the receiving reel comprises a gear portion engaged with the transmission-splined shaft portion; wherein the output reel comprises:
a tapered cylinder, centered on the output-center axis; and
an output slot, extending helically along and on the tapered cylinder;
wherein the first end of the transmission cord fixed on the output reel is close to a wide end of the tapered cylinder; while the extendable component is wound on the roller, the transmission cord is wound on the tapered cylinder along the output slot, causing radii of the output loops to gradually decrease during winding.

15. The window shade of claim 1, wherein the balancing drive system further comprises a fixed axle disposed to correspond to the one end of the roller, connected with the first bracket, and immovable relative to the first bracket; the receiving reel is mechanically coupled with the fixed axle; the base is engaged with the roller to be rotatable around the first axis with the roller, and the base is rotatably connected with the receiving reel.

16. The window shade of claim 15, wherein the elastic torque is transmitted via the output reel, the transmission cord, the friction member, and the receiving reel to provide an elastic force to the roller; when the external force is removed, a load borne by the roller increases with the released length of the extendable component; the plural receiving loops and/or the plural output loops are wound with radii thereof gradually increasing as the released length of the extendable component increases, thereby increasing the elastic force acting on the roller as the load borne by the roller increases.

17. The window shade of claim 16, wherein the receiving reel is fixedly connected to the fixed axle, and comprises a receiving slot having an annular shape and centered on the receiving-center axis; the receiving slot restricts the transmission cord such that after winding X turns around the receiving reel, the transmission cord is stacked onto a subsequent layer, resulting in the receiving loops stacked on one another to form plural stacking layers when the extendable component is fully unwound form the roller, wherein X is one of 1, 2, and 3; while the extendable component is unwound from the roller and the transmission cord is wound onto the receiving reel, the stacking layers increase in number as the receiving loops increase in number, so that radii of the receiving loops gradually increase.

18. The window shade of claim 16, wherein the receiving reel is fixedly connected to the fixed axle; the output reel comprises an output slot having an annular shape and centered on the output-center axis; the output slot restricts the transmission cord such that after winding Y turns around the output reel, the transmission cord is stacked onto a succeeding layer, resulting in the output loops stacked on one another to form plural coiling layers when the extendable component is fully wound on the roller, wherein Y is one of 1, 2, and 3; while the extendable component is wound onto the roller and the transmission cord is wound onto the output reel, the coiling layers increase in number as the output loops increase in number, so that radii of the output loops gradually increase.

19. The window shade of claim 16, wherein the fixed axle has one end extending into the chamber of the roller and having a fixed-splined shaft portion thereon; wherein the receiving reel comprises:
a conical cylinder, centered on the receiving-center axis;
a receiving slot, extending helically along and on the conical cylinder; and
a gear portion, connected with the conical portion and engaged with the fixed-splined shaft portion, so that the receiving reel is configured to rotate around the receiving-center axis relative to the base while the base rotates;
wherein the second end of the transmission cord fixed on the receiving reel is close to a small-radius end of the conical cylinder; while the extendable component is unwound from the roller, the transmission cord is wound on the conical cylinder along the receiving slot, causing radii of the receiving loops to gradually increase during winding.

20. The window shade of claim 16, wherein the fixed axle has one end extending into the chamber of the roller and having a fixed-splined shaft portion thereon; the receiving reel comprises a gear portion engaged with the fixed-splined shaft portion, so that the receiving reel is configured to rotate around the receiving-center axis relative to the base while the base rotates; wherein the output reel comprises:
a tapered cylinder, centered on the output-center axis; and
an output slot, extending helically along and on the tapered cylinder;
wherein the first end of the transmission cord fixed on the output reel is close to a narrow end of the tapered cylinder; while the extendable component is wound onto the roller, the transmission cord is wound onto the tapered cylinder along the output slot, causing radii of the output loops to gradually increase during winding.

21. The window shade of claim 15, further comprising:
an upper rail, fixedly disposed on the architecture, wherein the first bracket and the second bracket are fixedly disposed on the upper rail and spaced apart from each other, and the roller is rotatable around the first axis relative to the upper rail; and
a shading structure, having a top end edge connected to the upper rail; wherein the extendable component is connected with the shading structure, such that, while the extendable component is operated by the external force to wind on the roller, the extendable component drives the shading structure to fold successively from bottom to top, and, while the extendable component is operated by the external force to unwind from the roller, the extendable component drives the shading structure to unfold successively from top to bottom;
wherein the elastic torque is transmitted via the friction member, the output reel, the transmission cord, and the receiving reel to provide an elastic force to the roller; when the external force is removed, a load borne by the roller decreases with the released length of the extendable component; the plural receiving loops and/or the plural output loops are wound, with radii thereof gradually decreasing as the released length of the extendable component increases, thereby reducing the elastic force acting on the roller as the load borne by the roller decreases.

22. The window shade of claim 21, wherein the fixed axle has one end extending into the chamber of the roller and having a fixed-splined shaft portion thereon; wherein the receiving reel comprises:
a conical cylinder, centered on the receiving-center axis;
a receiving slot, extending helically along and on the conical cylinder; and
a gear portion, connected with the conical portion and engaged with the fixed-splined shaft portion so that the receiving reel is configured to rotate around the receiving-center axis relative to the base while the base rotates;
wherein the second end of the transmission cord fixed on the receiving reel is close to a large-radius end of the conical cylinder; while the extendable component is unwound from the roller, the transmission cord is wound onto the conical cylinder along the receiving slot, causing radii of the receiving loops to gradually decrease during winding.

23. The window shade of claim 21, wherein the fixed axle has one end extending into the chamber of the roller and having a fixed-splined shaft portion thereon; the receiving reel comprises a gear portion engaged with the fixed-splined shaft portion, so that the receiving reel is configured to rotate around the receiving-center axis relative to the base while the base rotates; wherein the output reel comprises:
a tapered cylinder, centered on the output-center axis; and
an output slot, extending helically along and on the tapered cylinder;
wherein the first end of the transmission cord fixed on the output reel is close to a wide end of the tapered cylinder; while the extendable component is wound onto the roller, the transmission cord is wound onto the tapered cylinder along the output slot, causing radii of the output loops to gradually decrease during winding.
